(19) United States
(12) Patent Application Publication
(10) Pub. No.: US 2026/0289611 A1
(43) Pub. Date: Sep. 24, 2026

(54) SYSTEM

(71) Applicant: SoftBank Group Corp., Tokyo (JP)

(72) Inventor: Kaichi NAKANO, Tokyo (JP)

(73) Assignee: SoftBank Group Corp., Tokyo (JP)

(21) Appl. No.: 19/560,282

(22) Filed: Mar. 9, 2026

(30) Foreign Application Priority Data
Mar. 19, 2025 (JP) 2025-044556

(51) Int. Cl. G06Q 30/0241; G06F 40/126; G06F 40/163; G06F 40/186; G06F 40/232; G06F 40/284; G06F 40/30; G06F 40/40; G06N 3/0455; G06N 3/0475; G06N 3/092

(52) U.S. Cl. CPC G06Q 30/0276; G06F 40/186; G06F 40/284; G06F 40/30; G06F 40/40; G06N 3/0455; G06N 3/0475; G06N 3/092; G06F 40/126; G06F 40/163; G06F 40/232

(57) ABSTRACT

A system includes a processor that is configured to provide an interface for inputting information, receive information input through the interface and store the received information in a database, generate, based on the stored information, a prompt sentence for instructing a generative AI model to generate a promotional text, input the generated prompt sentence into the generative AI model and automatically generate the promotional text by using the generative AI model, output the generated promotional text via a user interface, collect and analyze user reaction data in order to measure predetermined evaluation indicators, and apply a reinforcement learning algorithm based on measurement results of the evaluation indicators and adjust parameters of the generative AI model so as to improve quality of the promotional text.

### CROSS-REFERENCE TO RELATED APPLICATION

This application is based on and claims priority under 35 USC 119 from Japanese Patent Application No. 2025-044556 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for generating promotional texts typically rely on static rule-based templates or one-time use of generative AI models without systematic feedback from actual user reactions. As a result, the generated promotional texts are often not optimized for specific evaluation indicators such as click-through rates or conversion rates, and the quality of the promotional texts does not improve over time. Moreover, existing systems frequently separate the processes of text generation, performance measurement, and model improvement, requiring manual analysis and manual adjustment of the generative model or its prompts. This separation increases operational burden, slows down optimization cycles, and limits the ability to continuously tailor promotional texts to changing user behavior or campaign objectives.

Accordingly, there is a need for a system that can: (i) accept campaign-related information through an interface; (ii) automatically generate promotional texts using a generative AI model based on the input information; (iii) measure user reactions according to predetermined evaluation indicators; and (iv) automatically adjust the generative AI model and prompt generation method through reinforcement learning, so that the quality and effectiveness of the promotional texts are continuously improved without requiring manual intervention.

### SUMMARY

To solve the above problems, the present invention provides a system comprising a processor, wherein the processor is configured to provide an interface for inputting information, receive information input through the interface and store the received information in a database, and generate, based on the stored information, a prompt sentence for instructing a generative AI model to generate a promotional text. The processor is further configured to input the generated prompt sentence into the generative AI model and automatically generate the promotional text by using the generative AI model, and to output the generated promotional text via a user interface. In addition, the processor is configured to collect and analyze user reaction data in order to measure predetermined evaluation indicators, and to apply a reinforcement learning algorithm based on measurement results of the evaluation indicators and adjust parameters of the generative AI model so as to improve quality of the promotional text.

In some embodiments, the processor is configured to cause the promotional text automatically generated by using the generative AI model to be in a format deliverable as an electronic mail or a digital advertisement, thereby enabling direct deployment of the generated text in typical digital marketing channels. In further embodiments, the processor is configured to update a method for generating the prompt sentence for the generative AI model based on the measurement results of the evaluation indicators, and to generate a more effective promotional text at a time of a next promotional text generation. By integrating input acquisition, generative AI-based text generation, KPI measurement, and reinforcement learning-based model and prompt adaptation in a single system, the invention enables automatic, iterative improvement of promotional text effectiveness with reduced manual effort.

The term “system” refers to an integrated combination of hardware and software components that cooperate to execute the processing steps described in the claims, including at least one processor, memory, and interfaces for communication with users and external devices or services.

The term “processor” refers to one or more hardware processing units, such as a central processing unit (CPU), a graphics processing unit (GPU), a digital signal processor (DSP), or a combination thereof, that executes computer-readable instructions to perform the functions described in the claims.

The term “interface for inputting information” refers to any hardware and software mechanism that allows a user or an external system to provide information to the system, including but not limited to web forms, application screens, application programming interfaces (APIs), and command-line interfaces.

The term “database” refers to any structured data storage system, including relational databases, NoSQL databases, key-value stores, or other persistent storage mechanisms, in which the system stores and retrieves information used for generating and evaluating promotional texts.

The term “prompt sentence” refers to a text string or structured textual instruction generated by the processor, which is provided as input to a generative AI model to specify conditions, constraints, or objectives for generating a promotional text.

The term “generative AI model” refers to a machine learning model capable of automatically generating text in natural language based on received input, such as a large language model, a transformer-based model, or any other neural network-based text generation model.

The term “promotional text” refers to a text content generated by the generative AI model under control of the system, which is intended to promote a product, service, offer, or brand, and which may be used in advertising, marketing communications, or sales-related messages.

The term “user interface” refers to any interface through which the system presents generated promotional text and related information to a user, including graphical user interfaces (GUIs), web pages, dashboards, application screens, and programmatic responses of APIs.

The term “evaluation indicators” refers to quantitative or qualitative metrics used to evaluate the performance of the promotional text, including but not limited to click counts, click-through rates, open counts, open rates, conversion counts, conversion rates, or other key performance indicators (KPIs).

The term “user reaction data” refers to data indicating how end users respond to the promotional text, including actions such as opening an email, clicking a link, viewing a page, submitting a form, or completing a purchase, as well as timestamps and identifiers associated with such actions.

The term “reinforcement learning algorithm” refers to a machine learning method that adjusts parameters of a model or policy based on feedback signals in the form of rewards derived from evaluation indicators, so as to improve future performance of the model or policy.

The term “parameters of the generative AI model” refers to internal numerical values, weights, biases, or configuration settings of the generative AI model that determine its output behavior when generating text in response to input.

The term “format deliverable as an electronic mail” refers to a data format suitable for inclusion in or transmission as an email message, including plain text emails, HTML emails, or multipart email content that conforms to standard email protocols.

The term “format deliverable as a digital advertisement” refers to a data format suitable for use in digital advertising channels, including but not limited to banner ads, native ads, social media ads, search ads, or other online advertisement formats, which may require specific length, markup, or structural constraints.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

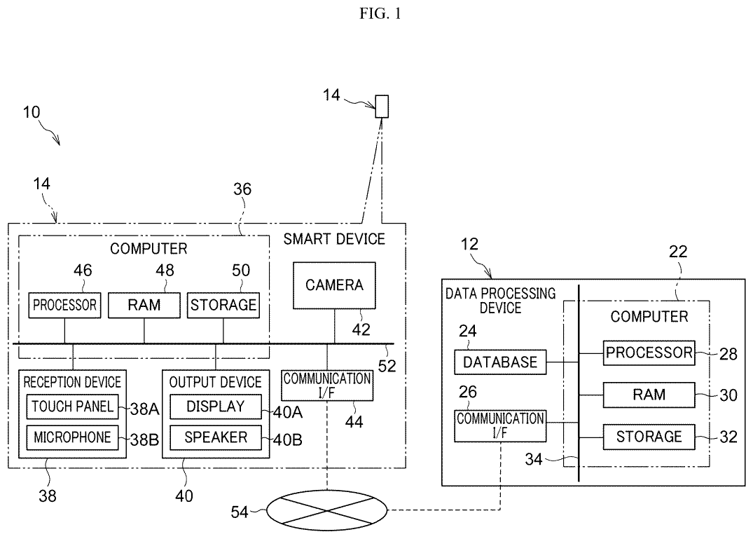

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

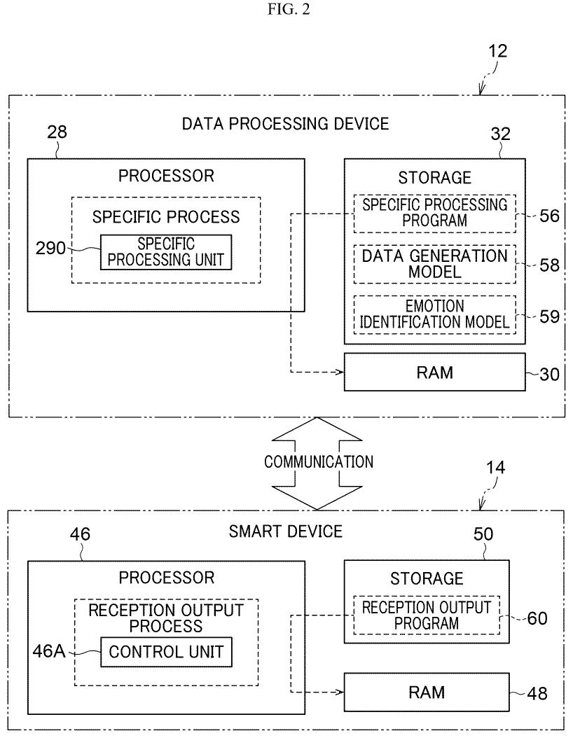

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems for generating promotional text using natural language generation models typically focus on one-shot text generation based on static user input. In such systems, the server generally receives campaign parameters, forwards those parameters or a simple prompt to a text generation engine, and returns the generated text to the user. However, these systems suffer from several technical shortcomings.

First, the server does not maintain a structured association between (i) detailed input conditions for text generation, (ii) the exact prompt sentences provided to a generative AI model, and (iii) subsequent user reaction data collected from external delivery and analytics systems. As a result, the underlying computing system cannot systematically learn which combinations of prompts and model parameters yield better performance, and server-side processing remains largely stateless and heuristic, rather than data-driven and optimized over time.

Second, existing architectures do not integrate a reinforcement learning loop at the server level that treats the entire sequence of operations—prompt construction, parameter selection, model invocation, and campaign distribution—as a controllable policy. In typical implementations, any tuning of the generative AI model or prompt design is performed manually offline by human operators. The server merely forwards requests and responses and does not execute a machine learning algorithm that interprets observed reaction data (such as click counts, view counts, and conversion counts) as reward signals. This lack of online learning prevents the system from automatically improving its text generation strategy, thereby limiting both the efficiency of server-side resource utilization and the effectiveness of promotional campaigns.

Third, conventional systems do not provide a mechanism for the server to combine implicit evaluation signals from external analytics (for example, numerical performance metrics) with explicit user feedback from terminals (for example, ratings or comparative selections among multiple text variants) in a unified reinforcement learning framework. Without such a unified reward model, the server cannot reliably update its internal policies for generating prompt sentences and selecting generation condition parameters. This leads to suboptimal use of computing resources, because the server repeatedly executes generative model calls under non-ideal conditions, performing similar computations without systematically improving the resulting output quality.

Fourth, existing solutions do not treat the prompt generation logic itself as a first-class, machine-learned component of the server. In many systems, prompt construction is implemented as a fixed template or a small set of manually crafted rules. These fixed rules are not updated based on measured performance, and they do not adapt to changing target segments, media channels, or reaction patterns. Consequently, the server's text generation pipeline cannot leverage its accumulated operational data to refine the way it forms instructions to the generative AI model.

Accordingly, there is a need for an improved computer-implemented system in which the server (i) manages structured storage of input conditions, prompt sentences, generated promotional texts, and reaction data, (ii) executes a reinforcement learning algorithm using these data as training signals, and (iii) automatically updates both generation condition parameters and prompt generation rules. Such a system can improve the technical operation of the server by enabling more efficient and adaptive control over how the generative AI model is invoked, thereby enhancing throughput, reducing ineffective generations, and systematically improving the quality and performance of generated promotional text across repeated executions.

The specific processing by the specific processing unit 290 of the data processing device 12 in Example 1 is realized by the following means.

The present invention provides a server comprising a processor and a storage device, the processor being configured to provide, via a communication network to a user terminal, a user interface for receiving target information, object information, appeal point information, and evaluation index information; to store, as structured data in an information storage area of the storage device, request data including the target information, the object information, the appeal point information, and the evaluation index information received from the user terminal; to generate, based on the structured data, a prompt sentence embedding text generation conditions and to record the prompt sentence in association with the structured data in a prompt recording area; to transmit, via a communication interface, generation request data including the prompt sentence and generation condition parameters to an external natural language generation service so as to cause a generative AI model executed by the external service to automatically generate promotional text data; to receive the generated promotional text data as response data and store the promotional text data in a generation result recording area in association with the corresponding prompt sentence and input conditions; to convert the promotional text data into at least one of a displayable format for the user interface and an electronic distribution format and to output the promotional text data to the user terminal and/or an external delivery system; to collect, after distribution of the promotional text data, reaction information including at least one of a number of clicks, a number of views, and a number of conversions from at least one external analysis service or advertising distribution service, and to compute, by statistical processing and aggregation processing on the reaction information in association with the evaluation index information, an evaluation index value; and to generate a reward signal based on at least the prompt sentence, the promotional text data, the evaluation index value, and optionally explicit evaluation information or comparative selection results received from the user terminal, to apply a reinforcement learning algorithm implemented by a machine learning library using the reward signal, and to update at least one of the generation condition parameters for the generative AI model and a generation rule for the prompt sentence so that, in subsequent executions, control over generation of promotional text data is adaptively modified to increase the evaluation index value. This enables the server to implement an improved, closed-loop text generation pipeline in which prompt construction and model parameter selection are automatically optimized based on accumulated reaction data and user feedback, thereby enhancing the technical performance of the computer system in generating high-effectiveness promotional text while making more efficient use of computational resources.

The term “processor” refers to a hardware-based or virtual computation unit, such as a central processing unit or a processing core in a computing device, that executes instructions to perform the functions described in the present disclosure.

The term “storage device” refers to a non-transitory computer-readable medium, such as a magnetic disk, solid-state drive, optical medium, or semiconductor memory, that is configured to store data and programs used by the processor.

The term “user terminal” refers to an information processing apparatus operated by a user, such as a personal computer, smartphone, tablet, or other communication-enabled device, that communicates with the server via a communication network.

The term “communication network” refers to a wired or wireless data communication infrastructure, such as the Internet, a local area network, a wide area network, or a mobile network, that enables data exchange between the server and one or more user terminals or external services.

The term “user interface” refers to a graphical, textual, or interactive presentation, such as a web page, application screen, or dialog, through which a user inputs information and receives output from the server.

The term “target information” refers to information indicating characteristics of an intended audience for a promotional activity, including at least one of demographic attributes, behavioral attributes, or preference attributes.

The term “object information” refers to information describing a product, service, or other subject matter to be promoted, including at least one of a name, category, feature, or usage description.

The term “appeal point information” refers to information specifying one or more features, advantages, or selling points that are to be emphasized in promotional text generation.

The term “evaluation index information” refers to information indicating at least one performance metric for assessing effectiveness of promotional text, such as a click count, view count, conversion count, or rate derived therefrom.

The term “request data” refers to data transmitted from the user terminal to the server via a communication protocol, the data including at least target information, object information, appeal point information, and evaluation index information.

The term “structured data” refers to data that is organized according to a defined schema, such as records with fields stored in a relational database or key-value pairs stored in a structured storage system, enabling indexed retrieval and association.

The term “information storage area” refers to a logical region within the storage device allocated for storing structured data, including user inputs, prompt sentences, generated text data, and associated metadata.

The term “prompt sentence” refers to a natural language or semi-structured instruction string that embeds text generation conditions and is provided as input to a generative AI model to cause the model to generate promotional text.

The term “prompt recording area” refers to a logical region within the storage device configured to store one or more prompt sentences in association with corresponding input conditions and metadata.

The term “generation condition parameters” refers to parameters that control operation of the generative AI model, including at least one of a model identifier, temperature value, maximum token length, sampling distribution parameter, or other model control setting.

The term “generation request data” refers to data sent from the server to an external natural language generation service, the data including at least a prompt sentence and generation condition parameters used to invoke the generative AI model.

The term “communication interface” refers to a hardware and software interface, such as a network interface card and associated communication stack, that enables the server to send and receive data over the communication network.

The term “external natural language generation service” refers to a remote information processing service accessible via the communication network, which executes one or more generative AI models to generate text in response to input prompts.

The term “generative AI model” refers to a machine-learned model, such as a neural network-based language model, trained to generate natural language output from input text including prompt sentences.

The term “promotional text data” refers to text-based data generated by the generative AI model that is intended to be used as a promotional message or advertisement content.

The term “response data” refers to data returned from the external natural language generation service to the server, the data including at least the promotional text data and optionally additional metadata.

The term “generation result recording area” refers to a logical region within the storage device configured to store promotional text data generated by the generative AI model in association with corresponding prompt sentences and input conditions.

The term “electronic distribution format” refers to a data format suitable for electronic delivery of promotional text, such as an email body format, messaging format, or advertising creative format.

The term “delivery system” refers to an external system that distributes promotional content to end users, such as an electronic mail distribution system, an advertising distribution system, or an information display system.

The term “reaction information” refers to performance data collected after distribution of the promotional text, including at least one of a number of clicks, a number of views, a number of conversions, or derived metrics.

The term “analysis service” refers to an external system or platform that measures and reports performance metrics for distributed content, such as web analytics or campaign analytics services.

The term “advertising distribution service” refers to an external system that delivers advertisements to end users and records performance data, such as impressions, clicks, and conversions.

The term “evaluation index value” refers to a numerical value or set of values computed from reaction information and evaluation index information, representing a quantified measure of effectiveness for a particular promotional text.

The term “reward signal” refers to a numerical or structured signal derived from at least the prompt sentence, the promotional text data, the evaluation index value, and optionally explicit evaluation information, used as input to a reinforcement learning algorithm.

The term “evaluation information” refers to explicit feedback data provided by a user via the user terminal, including at least one of ratings, scores, or qualitative evaluations of promotional text.

The term “comparative selection results” refers to data indicating user selections among a plurality of promotional text variants, such as binary choices, rankings, or preferences, collected via the user interface.

The term “reinforcement learning algorithm” refers to a machine learning procedure that updates a policy or model parameters by maximizing expected cumulative reward, based on observed reward signals.

The term “machine learning library” refers to a software framework or collection of routines that implements machine learning algorithms, including at least reinforcement learning, gradient-based optimization, and model parameter updates.

The term “generation rule for the prompt sentence” refers to a rule set, template, or learned policy used by the server to construct prompt sentences from input conditions, including decisions about wording, structure, and inclusion or weighting of elements.

The term “writing style of the prompt sentence” refers to stylistic characteristics of the prompt sentence, such as tone, level of formality, length, and rhetorical structure, which can be adjusted to influence the behavior of the generative AI model.

The term “structure of the prompt sentence” refers to the arrangement and ordering of elements within the prompt sentence, including the sequence in which target information, object information, appeal point information, and evaluation criteria are presented.

The term “control over generation of promotional text data” refers to the server's ability to influence the behavior of the generative AI model by selecting prompt sentences, generation condition parameters, and associated policies that guide the model's output.

In one embodiment, a server includes at least one processor, a main memory, a non-transitory storage device, and a network interface configured to communicate with one or more terminals operated by users and with one or more external text generation and analytics services. The server executes a server-side program implemented, for example, using an operating system, a web application framework (such as a general-purpose HTTP server and application framework), a database management system (such as a relational database engine), and a machine learning library (such as a deep learning framework supporting neural networks and reinforcement learning). The terminal includes a processor, a display device, an input device, a memory, and a network communication module, and executes a client application such as a web browser or a native application.

The server stores, in the storage device, program modules including at least a user interface module, a data management module, a prompt generation module, a generative-model interface module, a metrics collection module, and a reinforcement learning module. The server also stores data structures including an input record table, a prompt table, a generated text table, and a metrics table, each realized, for example, as tables in a relational database schema with primary keys and foreign keys.

The server provides a user interface module that outputs, via the network interface, markup data and script data to the terminal. The terminal renders these data as an input screen that includes fields for target information, object information, appeal point information, and evaluation index information. The user operates the terminal to input values into these fields and to transmit them to the server. The terminal encodes these values into structured request data, for example as key-value pairs in a message body, and transmits them to the server using a secure transport protocol.

The server uses the data management module to parse the received request data and to store the values in the input record table of the database. The input record table includes columns representing, for example, an input identifier, a user identifier, the target information, the object information, the appeal point information, the evaluation index information, and timestamps. By storing the data in a normalized relational schema, the server enables efficient indexed retrieval and joining across multiple tables, which improves the speed and scalability of subsequent analytical queries executed by the reinforcement learning module.

The server uses the prompt generation module to synthesize a prompt sentence for a generative AI model. The prompt generation module retrieves the stored target information, object information, appeal point information, and evaluation index information for a given input identifier from the database. The prompt generation module then constructs a natural language string that embeds these values according to a configurable pattern. In one example, the prompt generation module produces the following prompt sentence:

“Create a promotional text for women in their 20s about a new cosmetics line. Emphasize gentle ingredients suitable for sensitive skin and aim to maximize the number of clicks.”

In another example, when the user inputs information for an online course, the prompt generation module outputs the following prompt sentence:

“Create a promotional text for working professionals in their 30s about an online programming course. Emphasize the learn-at-your-own-pace structure and job-oriented curriculum, and aim to maximize the number of conversions.”

The server stores each generated prompt sentence in the prompt table, associated with the corresponding input identifier and with metadata such as a prompt identifier, a prompt pattern identifier, and a version identifier representing the prompt generation policy used. This explicit, versioned storage of prompt sentences and their relationships to input records enables the server to reproduce exact historical conditions and to evaluate different versions of prompt generation policies, which is a technical improvement over systems that discard or fail to log prompt-level information.

The server uses the generative-model interface module to call an external natural language generation service that hosts one or more generative AI models. In one embodiment, the generative AI model is a transformer-based neural network language model with multiple attention layers, feed-forward layers, and learned token embeddings. The model uses a vocabulary of tokens obtained by subword tokenization and has trainable parameters including weight matrices for self-attention, layer normalization parameters, and output projection matrices. The model has been pre-trained on large-scale text data and optionally fine-tuned on task-specific corpora.

The server constructs generation request data that includes at least the prompt sentence and generation condition parameters, such as a model identifier, a temperature scalar, a maximum number of tokens to generate, a top-k or top-p sampling parameter, and penalties for repetitive phrases. The generative-model interface module formats this data according to the external service's API specification and sends it via the network interface. The external service executes the generative AI model on specialized hardware, such as graphics processors or tensor processing units, to iteratively produce output tokens conditioned on the input prompt sentence. The external service returns response data including the generated text and optional token usage statistics.

The server receives the response data and stores the generated text in the generated text table. The generated text table contains, for each record, at least a generated text identifier, a foreign key to the prompt identifier, the generated promotional text data, the generation condition parameters used, and performance-related metadata such as generation time and token counts. By keeping explicit associations between generated text, prompt sentence, and input conditions in structured tables, the server can later compute statistical measures and reinforcement learning rewards in a computationally efficient manner, using index scans and join operations rather than ad hoc log parsing.

The server outputs the generated promotional text data to the terminal through the user interface module. The terminal displays the text in a dedicated area of the screen and may also provide functions for copying, editing, or previewing the text. The user may choose to deploy the promotional text via an external delivery system, such as an email delivery platform or an advertising platform. The server can convert the generated promotional text into formats expected by these systems, for example by wrapping the text in an email message structure or in a structured advertisement payload. This conversion may include inserting the text into templates, assigning subject lines derived from the prompt sentence, or encoding the text in character encodings compatible with the destination system.

The server uses the metrics collection module to collect reaction information after the promotional text has been delivered. The server may receive callbacks or periodically query endpoints of external analytics services and advertising distribution services to obtain numerical metrics such as click counts, impression counts, and conversion counts associated with a campaign identifier. The server stores these metrics in the metrics table, where each record includes at least a metrics identifier, a foreign key to the generated text identifier, measured values for each evaluation index (e.g., click count, conversion count), and timestamps. The server may also store derived values, such as click-through rate or conversion rate, which are computed by dividing counts by impressions or by applying other transformations.

The server uses the data management module to retrieve both implicit reaction information and explicit evaluation information collected from the terminal. The user may provide explicit feedback by assigning ratings to generated texts or by selecting one preferred text among multiple variants. The terminal encodes this feedback as evaluation information and sends it to the server, where it is stored as separate but linkable data records associated with the generated text identifiers. By combining both implicit and explicit signals, the server creates richer training data for the reinforcement learning module.

The server uses the reinforcement learning module to update a policy for choosing generation condition parameters and for constructing prompt sentences. In one embodiment, the reinforcement learning module implements a policy network realized as a neural network whose inputs include features derived from the target information, object information, appeal point information, evaluation index information, and historical performance statistics observed for similar inputs. The outputs of the policy network are control parameters, such as weights assigned to different phrase templates, selection probabilities for different orderings of prompt components, and suggested values for model parameters like temperature or maximum token length.

The server defines, in the reinforcement learning module, a reward function that takes as input the evaluation index value and the explicit evaluation information, and outputs a scalar reward. For example, the reward function may compute a weighted sum of normalized click-through rate and user rating, with a penalty term to discourage excessively long messages. The reinforcement learning module computes the reward for each interaction and stores these reward values in association with the prompt identifier and the generated text identifier.

The server uses a machine learning library to perform gradient-based optimization of the policy network. In one example, the server applies a policy gradient algorithm or an actor-critic method. The server computes gradients of an objective function that is based on expected reward with respect to the parameters of the policy network. The server updates the parameters by applying an optimization method such as stochastic gradient descent or an adaptive learning rate optimizer. The training data for this optimization consists of many past prompt-text-metrics tuples retrieved from the database, and the reward values computed from the metrics. By periodically retraining or incrementally updating the policy network, the server learns which combinations of prompt construction choices and generation condition parameters lead to higher evaluation index values.

The server then uses the updated policy network when constructing new prompt sentences. For example, the policy network may infer that, for certain target segments, prompting the generative AI model with explicit instructions about urgency and limited-time offers yields higher conversion rates. The prompt generation module, guided by the policy network outputs, adjusts the wording and ordering of elements in the prompt sentence accordingly. Similarly, the server may adjust the temperature parameter or maximum length parameter based on the policy's output, producing text that is more concise or more varied as appropriate for the observed campaign performance.

This configuration produces a technical effect beyond mere automation of human copywriting. Because the server treats the entire pipeline—from structured storage of inputs, to prompt construction, to generative model invocation, to metrics collection—as a closed-loop control system, the server improves its own computational behavior over time. The policy network and reinforcement learning mechanism reduce the number of ineffective or low-performing generations by steering the generative AI model toward parameter settings and prompt formulations associated with higher rewards. As a result, the server reduces wasted computation on poorly performing text variants, improving overall computation efficiency. Additionally, by storing and analyzing data in normalized tables optimized for machine learning workflows, the server accelerates retrieval and processing of large histories of interactions, thereby reducing server response times when constructing new prompts.

In another embodiment, the server uses a different reinforcement learning algorithm, such as Q-learning or a bandit algorithm, where the server maintains value estimates for discrete actions, such as selecting from a set of prompt templates or predefined temperature levels. The server updates these value estimates based on observed rewards and chooses actions according to an exploration-exploitation strategy. This embodiment may be advantageous when the prompt space is represented as a finite set of variants rather than a fully continuous parameterization.

In yet another embodiment, the generative AI model itself is fine-tuned by the reinforcement learning module. The server prepares training examples where the input is the prompt sentence and the desired output is promotional text that yielded high rewards. The server computes gradients of a loss function that penalizes divergence from high-reward outputs and uses the machine learning library to update the weights of the generative AI model. In such a configuration, the generative-model interface module coordinates the transfer of gradient updates to the external service, or the generative AI model is hosted directly on the server for fine-tuning. Although this embodiment requires additional computational resources, it can further improve text quality without changing the business logic layer.

The terminal may implement additional user interface variations. For example, the terminal may present multiple candidate promotional texts generated with different prompt variations suggested by the policy network. The user can quickly compare these variants side-by-side and provide comparative selections. The server then uses these selections as pairwise preference data in a preference learning algorithm that refines the reward model. This process allows the system to capture nuanced human judgments that go beyond simple numeric metrics, resulting in improved alignment between the generative AI model's outputs and user preferences.

The described architecture and data flow are not limited to promotional text for email or advertising channels. The same server, generative AI model, and reinforcement learning framework can be applied to any context where text generation quality is measured by quantifiable reaction data, such as message engagement in notification systems, headline optimization in content platforms, or automated suggestions in customer support interfaces. In each case, the server's technical improvement resides in its ability to store, associate, and leverage detailed prompt-level and metrics-level data to systematically adjust its policies, thereby increasing the efficiency and effectiveness of the underlying computing process, rather than merely digitizing a manual workflow.

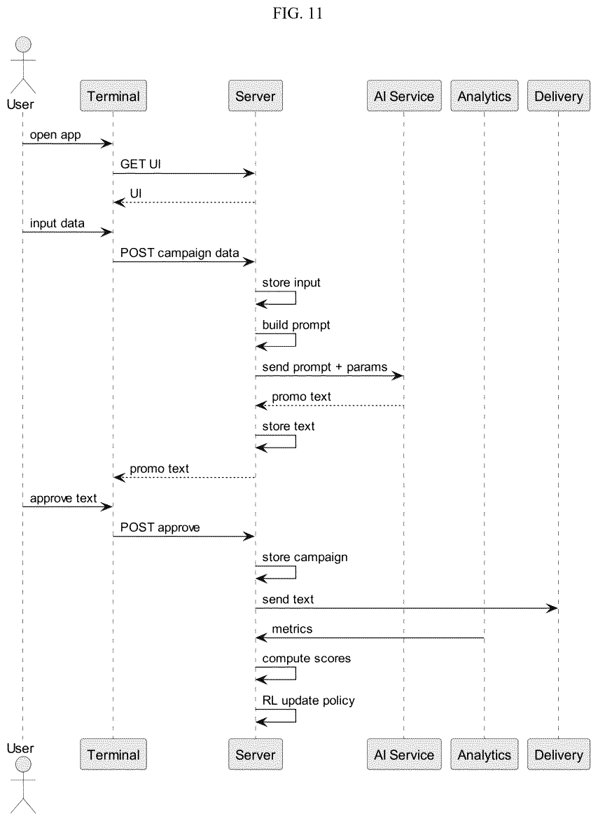

The following describes the processing flow using FIG. 11.

### Step 1:

The user operates the terminal to open a client application, such as a web browser or native app, and requests an input screen from the server.

The terminal sends an HTTP GET request as input to the server and receives an HTML/JavaScript page or structured UI description as output from the server. The terminal renders the received data into visual components including text fields, drop-down menus, and buttons.

### Step 2:

The user inputs target information, object information, appeal point information, and evaluation index information into the fields displayed on the terminal.

The terminal takes the user keystrokes and selections as input, performs basic validation such as checking non-empty fields and allowed value ranges, and produces a structured data object (for example, a set of key-value pairs) as output that represents the user's campaign settings.

### Step 3:

The terminal sends the structured data object to the server as request data.

The terminal uses the structured object as input, serializes it into a message body (for example, JSON or URL-encoded form data), and outputs an HTTP POST request over a secure network connection to the server. The request includes fields such as target, object, appeal_points, and evaluation metric.

### Step 4:

The server receives the HTTP POST request and parses the request body.

The server uses the raw HTTP message as input, applies a web framework parser to extract the data fields, validates types and lengths, and outputs a normalized in-memory representation, such as a typed record or dictionary, containing the target information, object information, appeal point information, and evaluation index information.

### Step 5:

The server stores the normalized representation in a database as an input record.

The server uses the in-memory record as input, maps each field to columns in an input table (for example, input_id, user_id, target, object, appeal points, evaluation_index), and executes an SQL INSERT operation. The server outputs a persistent row in the database and an input identifier that uniquely references the stored record.

### Step 6:

The server retrieves the stored input record and constructs a prompt sentence for a generative AI model.

The server uses the input identifier as input to a database query, fetches the associated target, object, appeal points, and evaluation index, and applies a prompt template algorithm that concatenates these values with fixed phrases. From this processing, the server outputs a prompt sentence such as:

“Create a promotional text for women in their 20s about a new cosmetics line. Emphasize gentle ingredients suitable for sensitive skin and aim to maximize the number of clicks.”

### Step 7:

The server records the generated prompt sentence in a prompt table linked to the input record.

The server uses the prompt sentence and input identifier as input, assigns a new prompt identifier, and executes an SQL INSERT into a prompt table with fields such as prompt_id, input_id, prompt_text, and policy_version. The output of this step is a persistent association between the input conditions and the exact prompt sentence.

### Step 8:

The server prepares generation request data and sends it to an external generative AI model service.

The server uses the prompt sentence, generation condition parameters (for example, model name, temperature, maximum tokens), and authentication credentials as input, encodes them into an API request payload, and outputs an HTTPS request to the external service. This request instructs the external generative AI model to generate promotional text based on the prompt sentence.

### Step 9:

The external generative AI model service generates promotional text and returns it to the server.

The external service uses the prompt sentence and generation parameters as input, tokenizes the text, performs neural network inference using a transformer-based model to compute probability distributions over tokens, and iteratively selects output tokens according to the sampling parameters.

The service aggregates the tokens into a text string and outputs response data containing the generated promotional text back to the server.

### Step 10:

The server receives the response data and extracts the promotional text.

The server uses the raw HTTP response as input, parses the JSON body, and locates the text field returned by the generative AI model. From this parsed structure, the server outputs the generated promotional text as a string and optionally extracts metadata such as token usage and processing time.

### Step 11:

The server stores the generated promotional text in a generated text table associated with the prompt and input records.

The server uses the promotional text string, prompt identifier, and input identifier as input, formats them into an INSERT statement, and writes a new row in the generated text table with fields such as text_id, prompt_id, input_id, generated_text, model_parameters, and timestamps. The output is a persistent record enabling later retrieval and analysis of the generated text.

### Step 12:

The server formats the promotional text for display and distribution and sends it to the terminal.

The server uses the generated text and user interface configuration as input, embeds the text into an HTML template or structured response object, and outputs a response message to the terminal. The response includes a representation of the promotional text suitable for rendering on the screen and may also include alternative formats, such as plain text segments for download or further processing.

### Step 13:

The terminal receives the server response and displays the promotional text to the user.

The terminal uses the response message as input, executes rendering logic to extract the promotional text field, and outputs visual content on the display, for example in a result panel. The terminal also activates UI controls (for example, “Copy”, “Edit”, “Send”) that reference the displayed text.

### Step 14:

The user reviews, optionally edits, and approves the promotional text on the terminal.

The user uses the displayed text as input, modifies words or phrases directly in an editable text area if desired, and outputs a final approved version by triggering a command such as “Use this text” or “Start campaign.” The terminal packages the approved text and associated campaign settings into a structured payload.

### Step 15:

The terminal sends the approved promotional text and campaign settings back to the server.

The terminal uses the approved text and user selections (such as delivery channel and schedule) as input, serializes them as a message, and outputs an HTTP POST request to the server. This request carries the final promotional text to be used for distribution and metadata required by external delivery systems.

### Step 16:

The server receives the approved text and initiates integration with an external delivery system.

The server uses the approved text and campaign settings as input, converts the text into an appropriate electronic distribution format (for example, an email body structure or an advertisement payload), and outputs API calls or formatted messages to at least one external delivery system. The server also stores a campaign record linking the approved text to identifiers used by the delivery

### Step 17:

The server collects reaction information from external analytics and advertising services after distribution.

The server uses campaign identifiers and delivery logs as input, sends scheduled queries or receives callbacks from external services, and obtains raw metrics such as click counts, view counts, and conversion counts as output. The server then writes these raw metrics into the metrics table, associating each record with the corresponding generated text and campaign.

### Step 18:

The server computes evaluation index values from the collected reaction information.

The server uses the raw metrics and evaluation index information as input, performs calculations such as division, normalization, and aggregation (for example, computing click-through rate by dividing clicks by impressions), and outputs evaluation index values representing performance scores for each generated text. These evaluation index values are stored in the metrics table for later use.

### Step 19:

The server collects explicit evaluation information or comparative selection results from the terminal.

The user provides ratings or preferences via the terminal, and the terminal sends these as evaluation data to the server. The server uses this evaluation data as input, associates it with specific generated text identifiers, and outputs additional records in an evaluation table that complement the numerical metrics stored in the metrics table.

### Step 20:

The server constructs training samples for reinforcement learning from historical prompts, texts, and metrics.

The server uses data from the input table, prompt table, generated text table, metrics table, and evaluation table as input, performs database joins and feature extraction to create structured samples where each sample contains features (such as target attributes and prompt structure) and labels (such as evaluation index values and user ratings). The server outputs a training dataset in a format acceptable to a machine learning library.

### Step 21:

The server applies a reinforcement learning algorithm to update a policy for prompt generation and model parameters.

The server uses the training dataset and a current policy model as input, computes rewards from evaluation index values and explicit feedback, and performs gradient-based updates using a machine learning library. The output is an updated set of policy parameters that specify how to choose or weight prompt templates, how to order components of the prompt sentence, and how to set generation condition parameters (for example, temperature, maximum tokens) for the generative AI model.

### Step 22:

The server uses the updated policy to influence subsequent prompt generation and text generation requests.

The server uses new input records together with the updated policy parameters as input, computes recommended prompt structures and parameter values, and outputs refined prompt sentences and generative AI model settings for future generations. As a result, the server's subsequent calls to the external generative AI model are guided by learned policies that are expected to yield higher evaluation index values, improving computational efficiency and text effectiveness over time.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented content generation systems that utilize machine learning or generative models typically treat the content-generation component as a black box and merely replace manual copywriting with automatic text output. In such systems, the processor generally accepts user input, sends that input directly or in a lightly formatted form to a generative model, receives an output, and displays the output to a user. These systems suffer from several technical drawbacks in terms of computer technology itself.

First, conventional systems lack a structured and machine-optimizable representation of user input parameters, such as promotion target, appeal subject, point to be emphasized, and evaluation indicator. Input is often passed as unstructured free text, which prevents the processor from systematically normalizing and reusing the data across different generations and from exploiting the data in a programmatic feedback loop. As a result, the processor cannot efficiently adapt its generation behavior without manual intervention and heuristic tuning, which wastes processing resources and network calls to the generative model.

Second, existing systems do not provide a computer-implemented mechanism that integrates measured user reaction data, such as display counts, selection counts, and conversion counts, into a unified reinforcement learning loop that directly controls prompt sentence composition and model parameter settings. In typical deployments, analytics data remains separated in external analytics platforms, and any adjustments to prompts or model parameters are performed manually by human operators. This separation hinders the processor from automatically identifying effective expression patterns, tones, lengths, and call-to-action phrases, and prevents the system from achieving a closed-loop optimization of generative behavior at the machine level.

Third, conventional systems generally lack a structured method for performing post-processing on generated text and associating that processed text with detailed campaign metadata, prompt sentences, evaluation values, and learning history. The absence of such associations makes it difficult for the processor to compute time-series or campaign-level performance metrics and to utilize those metrics as direct reward signals for a learning algorithm that adapts how prompt sentences are constructed and how generation parameters are set. Consequently, the system cannot systematically improve its generation quality over time using the computing environment itself, and any improvements are often ad hoc and not reproducible.

Fourth, existing systems that distribute generated content to external information distribution platforms often use static templates or fixed API call patterns and do not dynamically change generation conditions, such as temperature or output length, in response to measured performance. This leads to inefficiencies in the use of processing resources of both the local processing apparatus and the remote generative model, since the system repeatedly generates suboptimal texts without leveraging past performance signals. The processor is therefore unable to automatically generate diverse and high-performing promotional texts for the same input information.

Accordingly, there is a need for an improved computer-implemented system and server that (i) structures user input into normalized generation data, (ii) generates prompt sentences in a controllable and updatable format, (iii) acquires and aggregates reaction log data as evaluation values, and (iv) uses reinforcement learning within the processor to adapt both prompt sentence composition rules and generative model parameters. Such a system should close the loop between input, generation, distribution, measurement, and learning in a technically integrated manner, thereby improving the operation of the computer itself in automatically producing promotional text that is continually optimized based on actual user behavior.

The specific processing by the specific processing unit 290 of the data processing device 12 in Application Example 1 is realized by the following means.

The present invention provides a server comprising a processor, a storage device, a user input/output device interface, and a communication interface, wherein the processor is configured to control the user input/output device interface to display an input interface that allows a user to input structured information including at least a promotion target, an appeal subject, a point to be emphasized, and an evaluation indicator, to receive character string information input through the input interface, to store the received character string information as structured data in the storage device, to perform normalization processing and removal of unnecessary characters on the structured data so as to generate generation data, to generate a prompt sentence for input to a generative AI model by combining respective items of the generation data as labeled text and by constructing the prompt sentence including indications corresponding to the promotion target, the appeal subject, the point to be emphasized, the evaluation indicator, and instruction text relating to generation conditions, to input the prompt sentence, via the communication interface and a communication network, into the generative AI model, to cause the generative AI model to automatically generate promotional text data based on natural language processing and to extract the promotional text data from a response data set, to perform post-processing on the extracted promotional text data including deletion of unnecessary parts, truncation based on a character count limit, correction of notation inconsistencies, and format adjustment, thereby generating a final promotional text, to output the final promotional text to the user input/output device interface for display on a user interface and to accept an editing operation by the user, to acquire the final promotional text confirmed by the user together with designation information of at least one distribution medium and to transmit the final promotional text, through the communication interface and the communication network using a connection application interface of an external information distribution platform, as electronic distribution data, to acquire, from at least one of the external information distribution platform and an access analysis platform, log data indicating user behavior including a number of displays, a number of selections, a number of conversions, and other usage actions associated with the final promotional text, to aggregate and calculate evaluation values corresponding to the evaluation indicator based on the log data, thereby collecting and analyzing user reaction data, to store in the storage device the final promotional text, the generation data, the prompt sentence, the evaluation values, and an update history of a reinforcement learning algorithm in association with each other, to execute a learning process that performs the reinforcement learning algorithm using the evaluation values as a reward signal so as to update internal parameters representing at least composition rules of the prompt sentence and generation conditions for the generative AI model, to automatically change, based on an update result of the reinforcement learning algorithm, instruction text, constraint conditions, and tone designations in the prompt sentence to be input to the generative AI model, and to dynamically set at least one of a temperature parameter, an output length limit parameter, and an occurrence frequency control parameter for the generative AI model, so that expression patterns, tones, lengths, and call-to-action expressions that yield higher evaluation values are preferentially used in subsequent prompt sentence generation and so that diverse promotional texts that achieve higher evaluation indicators can be sequentially generated even for identical input information. This enables the server to implement a closed-loop computer-implemented optimization process in which user input is normalized, prompt sentences are systematically constructed, generative output is post-processed and distributed, reaction log data is fed back as evaluation values, and reinforcement learning is applied to adapt both prompt composition and generative model parameters, thereby improving the efficiency, adaptability, and output quality of the promotional text generation functions executed by the computer system.

The term “processor” refers to a hardware-implemented computation unit, such as a central processing unit or an execution core, that executes instructions to perform data processing, control logic, and communication operations in the system.

The term “storage device” refers to a non-transitory computer-readable medium, such as a semiconductor memory, a magnetic storage device, or an optical storage device, that stores programs, structured data, log data, and model parameters used by the processor.

The term “user input/output device” refers to an electronic apparatus, such as a display device, a touch panel, a keyboard, a pointing device, or a combination thereof, that allows a user to input information to the system and to receive output information from the system.

The term “user interface” refers to a presentation of information and input controls, such as screens, forms, buttons, and text fields, that is rendered on the user input/output device and that enables interaction between the user and the system.

The term “communication interface” refers to a hardware and software communication module, such as a network interface card and associated protocol stack, that enables the processor to send data to and receive data from external devices or services via a communication network.

The term “communication network” refers to a wired or wireless data transmission infrastructure, such as a local area network, a wide area network, or a public data network, that interconnects the server, terminals, and external platforms.

The term “promotion target” refers to an object or group to which a promotional message is directed, such as a category of users, a market segment, or a demographic group.

The term “appeal subject” refers to a characteristic or feature of a product, service, or offering that is intended to be highlighted in promotional text.

The term “point to be emphasized” refers to a particular aspect, benefit, or advantage of the appeal subject that is intended to be strongly stressed in promotional text.

The term “evaluation indicator” refers to a quantitative or qualitative metric, such as a click rate, a conversion rate, or a number of responses, that is used to evaluate performance of a promotional text.

The term “character string information” refers to data represented as sequences of characters, including letters, numerals, symbols, and control codes, that are input by the user and processed by the processor.

The term “structured data” refers to data that is organized according to a predefined schema or data model, such as key-value pairs, records, or table entries, which allows systematic access and processing by the processor.

The term “normalization processing” refers to a procedure that converts input data into a standardized or canonical form, including operations such as trimming whitespace, unifying character encodings, and standardizing delimiters.

The term “removal of unnecessary characters” refers to a processing operation that eliminates characters or substrings that are not required for subsequent generation or analysis, such as control codes, markup fragments, or extraneous symbols.

The term “generation data” refers to normalized and processed structured data derived from user input and stored by the processor for use in constructing prompt sentences and generating promotional text.

The term “prompt sentence” refers to one or more text sequences provided as input to a generative AI model, the text sequences including labeled information and instructions that condition or guide generation of output text.

The term “labeled text” refers to text in which data items are associated with explicit labels or descriptors, such as “Target:” or “Evaluation indicator:”, to make their roles and meanings identifiable for further processing.

The term “instruction text” refers to a portion of a prompt sentence that describes conditions, constraints, style requirements, or other directives regarding how the generative AI model should generate output text.

The term “generation conditions” refers to parameters or constraints that control behavior of the generative AI model, such as desired length, tone, style, or inclusion of a call-to-action phrase.

The term “generative AI model” refers to a machine-learned model, such as a neural network-based language model, that generates text or other content in response to input data including a prompt sentence.

The term “promotional text data” refers to text generated by the generative AI model that is intended to be used as a promotional message for a product, service, or offering.

The term “response data set” refers to data returned from the generative AI model in response to a prompt sentence, including at least the generated text and optionally additional metadata.

The term “post-processing” refers to a sequence of processing operations performed on generated text after receipt from the generative AI model, including cleaning, trimming, correcting, and formatting.

The term “final promotional text” refers to promotional text that has been generated by the generative AI model, subjected to post-processing, and optionally edited and confirmed by the user for distribution.

The term “distribution medium” refers to a communication channel or platform through which the final promotional text is delivered to end users, such as an electronic mail service, a social information service, or an advertising delivery service.

The term “external information distribution platform” refers to an externally provided system or service that distributes content to end users, including but not limited to electronic messaging platforms, social networking services, and advertisement delivery platforms.

The term “connection application interface” refers to an application programming interface provided by an external information distribution platform, through which the processor transmits content and control data.

The term “electronic distribution data” refers to formatted data transmitted from the server to an external platform for the purpose of delivering the final promotional text to end users.

The term “access analysis platform” refers to an external or internal analytics system that collects and provides information about user interactions with distributed content, such as impressions, clicks, and conversions.

The term “log data” refers to recorded data representing events or actions, including user behavior such as content displays, selections, and conversions, that are associated with promotional texts.

The term “user behavior” refers to observable actions performed by users in response to displayed promotional texts, including actions such as viewing, selecting, clicking, or performing a conversion.

The term “evaluation value” refers to a numerical or categorical value computed from log data in accordance with an evaluation indicator, representing performance of a specific promotional text or campaign.

The term “user reaction data” refers to a set of data, derived from log data and evaluation values, that characterizes how users respond to promotional texts over time or across campaigns.

The term “reinforcement learning algorithm” refers to a machine learning procedure in which a policy, model, or parameter set is adjusted to maximize a reward signal derived from observed outcomes.

The term “reward signal” refers to a scalar or vector value used by a reinforcement learning algorithm to indicate desirability of a particular action, configuration, or output, the reward signal being based on evaluation values.

The term “internal parameters” refers to adjustable values stored in the storage device or memory that determine behavior of the processor when constructing prompt sentences or setting generative model conditions.

The term “composition rules of the prompt sentence” refers to rules or patterns used by the processor to arrange labels, data items, and instruction text into a structured prompt sentence.

The term “generation conditions for the generative AI model” refers to a set of parameters or constraints that are provided to or used with the generative AI model to influence how output text is generated.

The term “update history of the reinforcement learning algorithm” refers to stored records of changes made to internal parameters, policies, or model weights each time the reinforcement learning algorithm is executed.

The term “temperature parameter” refers to a control value used by a generative AI model during probabilistic sampling, the control value affecting randomness and diversity of generated text.

The term “output length limit parameter” refers to a control value that specifies a maximum number of tokens, characters, or units of text to be generated by the generative AI model.

The term “occurrence frequency control parameter” refers to a control value that influences the probability of repeated appearance of words, phrases, or tokens in the generated text.

The term “expression pattern” refers to a particular arrangement of words or phrases, including wording style and structure, used in a promotional text.

The term “tone designation” refers to a specification of desired stylistic characteristics of text, such as being formal, casual, urgent, or friendly.

The term “call-to-action expression” refers to a phrase or sentence included in a promotional text that instructs or encourages a user to perform a specific action, such as clicking a link or making a purchase.

The term “time series unit” refers to a time-based segmentation, such as per hour, per day, or per campaign period, used for aggregating and analyzing evaluation indicators.

The term “campaign unit” refers to a logical grouping of promotional texts, distribution events, and evaluation records that are associated with a particular promotional objective or period.

The term “visualization data” refers to data formatted for graphical representation, such as values arranged for charts or graphs, to display changes or distributions of evaluation indicators.

The term “indicator display screen” refers to a user interface screen that presents visualization data regarding evaluation indicators, such as charts, tables, or dashboards.

In one embodiment, a server includes a processor, a storage device, a communication interface, and a user input/output interface coupled to one or more terminals operated by users. The processor executes application software implemented, for example, using a programming language such as Python and a web framework such as a generic web application framework. The server stores data and models on a non-transitory computer-readable storage device such as a solid-state drive or magnetic disk, and communicates with a generative AI model over a packet-based communication network such as the Internet.

The server provides to a terminal an interactive user interface implemented in markup language and script language. The terminal executes a browser or native client application and renders an input screen that contains separate input fields for a promotion target, an appeal subject, a point to be emphasized, and an evaluation indicator. The user operates the terminal to input natural language expressions into these fields. For example, the user may input:
Target: people interested in eco-friendly products
Appeal item: a new reusable eco bag
Selling point: supports a sustainable lifestyle and is easy to carry
KPI: click-through rate 5% on SNS ads

The terminal transmits these strings as structured data to the server. The server receives the data through the communication interface and stores them as records in a structured data store. The server uses an internal schema in which each promotion instance is represented as a record with named fields (e.g., target, appeal_item, selling point, kpi, campaign_id, timestamp). The storage device maintains tables indexed by campaign identifier and by time, enabling efficient retrieval and aggregation.

The server normalizes the received character string information by executing specific string-processing routines. The processor converts character encodings to a unified internal format, removes control characters, and trims leading and trailing whitespace. The server further standardizes separators, unifies numerical formats (for example, converting “5%” and “5 percent” into a canonical numeric value and unit representation), and stores both the original textual values and normalized representations. This normalization reduces ambiguity and enables deterministic construction of prompt sentences and evaluation indicators, which, in turn, improves computational consistency and reduces parsing errors.

The server constructs a prompt sentence for a generative AI model by combining the normalized fields into labeled text segments. The processor uses a deterministic composition rule set stored as internal parameters. In one example, the server constructs the following prompt sentence:
Target: people interested in eco-friendly products
Appeal item: a new reusable eco bag
Selling point: supports a sustainable lifestyle and is easy to carry
KPI: click-through rate 5% on SNS ads

Based on this information, generate a short, persuasive promotional text that encourages users to click. Use clear and engaging language, and include a call to action.

The server may adjust this prompt sentence based on previously learned parameters. For instance, the server may insert additional instructions such as “Place the discount information in the first sentence” or “Limit the text to 90 characters” when the reinforcement learning component has determined that these conditions correlate with higher evaluation indicators.

The server communicates with a generative AI model that is implemented as a neural network-based language model. In one embodiment, the generative AI model is a transformer architecture comprising multiple layers of self-attention and feed-forward sublayers, trained on large-scale text corpora using an objective function such as next-token prediction. The model internally represents tokens as high-dimensional embedding vectors and processes sequences of tokens using positional encoding and multi-head attention mechanisms. The server accesses this generative AI model via an application programming interface provided by an external model hosting service, or via a locally deployed inference engine.

The server provides the prompt sentence to the generative AI model together with generation parameters including at least a temperature parameter, an output length limit parameter, and an occurrence frequency control parameter. The temperature parameter scales the logits prior to sampling to control randomness. The output length limit parameter restricts the maximum number of tokens, thereby bounding computation time and network payload size. The occurrence frequency control parameter, such as a repetition penalty, reduces the probability of repeating tokens or phrases, improving textual diversity and reducing redundancy.

The generative AI model converts the prompt sentence into a token sequence, propagates the sequence through its layers, and outputs probability distributions over tokens at each position. The model selects tokens according to the configured sampling strategy influenced by the temperature and frequency parameters. The model returns generated tokens that the server decodes back into text, forming the initial promotional text data.

The server applies post-processing operations to the generated promotional text. The processor removes extraneous prefixes or disclaimers, constrains length to a target character count by truncating at token boundaries, and corrects basic typographical inconsistencies using pattern matching and rules. The server optionally enforces platform-specific constraints; for example, for a microblogging service distribution, the server ensures that the promotional text does not exceed a predefined character limit and that any required hashtags or links are correctly formatted.

The server outputs the resulting final promotional text to the terminal. The terminal displays the text in an editable text field, allowing the user to modify or fine-tune expressions. The user may, for example, change “tap to get your special offer now” to “click to enjoy a 5% eco discount now.” The terminal then returns the confirmed final promotional text and selected distribution media (such as an electronic mail platform and a social information platform) to the server.

The server associates the final promotional text with campaign metadata, including the original input parameters, the constructed prompt sentence, generation parameters, and a campaign identifier. The storage device records these associations so that each final promotional text can later be related to specific model settings and prompt composition rules. This structured association is technically advantageous because it permits the server to perform efficient queries and to compute evaluation indicators per prompt structure and parameter combination, which directly supports the learning and optimization routines.

The server uses connection application interfaces provided by external information distribution platforms to distribute the final promotional text. The processor formats API payloads containing the final text and additional metadata such as audience segments, scheduling parameters, and tracking identifiers. The communication interface transmits these payloads over the communication network using secure protocols. The external platforms deliver the promotional text to end users as electronic messages, social posts, or digital advertisements.

The server periodically acquires log data from at least one of the external information distribution platform and an access analysis platform. The processor retrieves metrics such as impressions (number of displays), clicks (number of selections), and conversions (specific actions such as purchases or sign-ups). The server parses the received log data and maps each log entry to the corresponding campaign identifier and final promotional text using embedded tracking identifiers and timestamps.

The server computes evaluation values that correspond to the evaluation indicators. For example, the server calculates a click-through rate by dividing the number of clicks by the number of impressions, and calculates a conversion rate by dividing the number of conversions by the number of clicks or impressions. The server stores these evaluation values in the storage device, indexed by campaign, time series unit, prompt structure, and generation parameters.

The server executes a reinforcement learning algorithm that uses the evaluation values as reward signals. In one embodiment, the server implements a contextual bandit algorithm or policy gradient algorithm using a numerical computation library. The server represents each action as a combination of prompt construction options (for example, placement of call-to-action phrases, length constraints, tone selection) and generation parameter configurations (for example, temperature and frequency control settings). The server represents each context as a feature vector derived from the normalized generation data, including encoded representations of the target, appeal subject, point to be emphasized, and evaluation indicator.

The server defines a reward function that maps evaluation values, such as click-through rate or conversion rate, into scalar reward signals. During learning, the processor updates internal parameters representing a policy function that maps from context features to action selections. In one example, the policy function is realized by a shallow neural network or a linear model that outputs scores for candidate prompt composition patterns and parameter sets. The processor performs gradient-based optimization to reduce a loss function defined as a negative expected reward plus regularization terms, and updates the policy parameters accordingly. The server records the update history, including parameter versions and corresponding performance metrics, in the storage device.

Through this reinforcement learning mechanism, the server autonomously discovers non-obvious correlations between prompt sentence structures, model parameters, and resultant evaluation indicators. For example, the server may learn that for campaigns targeting environmentally conscious users, a moderate temperature parameter and a call-to-action at the beginning of the text yield higher click-through rates, while for campaigns focused on price-sensitive users, highlighting discounts in the second sentence with a lower temperature parameter yields better performance. The server encodes such strategies into updated composition rules and parameter selection logic.

The server uses the updated internal parameters when constructing prompt sentences and setting generation conditions for subsequent campaigns. Instead of merely automating human copywriting, the system changes the internal flow of data and control within the computer. The prompt composition module dynamically selects prompt templates and instruction texts according to the learned policy, and the parameter selection module calculates concrete values for temperature, output length limit, and occurrence frequency control based on context features. This results in a technical improvement: the computer performs fewer trial generations with poor performance, thereby reducing unnecessary network traffic to the generative AI model and lowering computational load on both the server and the model host. Additionally, the improved prompt and parameter selection leads to higher success rates for each generation, which increases throughput and reduces latency for producing acceptable promotional texts.

The terminal can request and display analytical dashboards generated by the server. The server aggregates evaluation values per time series unit and per campaign unit, constructs data structures optimized for visualization (such as arrays of timestamp-value pairs), and transmits them to the terminal. The terminal renders charts showing trends in click-through rates and conversions. This monitoring function, supported by the structured storage of prompts, texts, and performance, makes it possible for the server to further refine the learning process, for example by selecting which campaigns to prioritize for exploration of new prompt variants versus exploitation of known effective patterns.

The system produces technical effects beyond mere automation of human tasks. By normalizing structured input, by defining specific data schemas for campaigns and logs, by explicitly representing prompt composition rules and generation conditions as machine-updatable parameters, and by integrating reinforcement learning that operates directly on these internal structures, the server improves the efficiency and performance of the underlying computing environment. The server reduces redundant network calls to the generative AI model, decreases storage of low-value content variations, and increases the probability that each generated text will meet evaluation thresholds. These effects manifest as improved processing speed, improved accuracy of promotional text effectiveness predictions, improved data management through consistent schemas and indices, and reduced communication load between the server and external services.

In another embodiment, the generative AI model is deployed locally on the same physical server or on a co-located accelerator device such as a graphics processing unit. The server loads a pre-trained transformer-based language model into memory and executes inference operations without requiring external API calls. In this configuration, the reinforcement learning component can also adjust internal model weights through fine-tuning. The server uses mini-batches of past prompts and generated texts, along with associated evaluation values, to compute gradients of a loss function based on policy gradient methods or actor-critic methods. The server updates selected layers of the language model (for example, output projection layers or adapter layers) while freezing other layers to control computational cost. This alternative embodiment further reduces network latency and allows fine-grained control over model behavior, providing an additional technical improvement in environments where local computation is preferred.

In yet another embodiment, the server uses a rule-based preprocessing module in combination with the generative AI model. The rule-based module applies non-conventional ordering and filtering to the normalized generation data before composing the prompt sentence. For instance, the module may reorder components so that the evaluation indicator appears earlier in the prompt for certain categories of campaigns, contrary to typical human practice, but discovered through reinforcement learning to be more effective. The server systematically explores such non-intuitive combinations, using the evaluation values as feedback, and selects those rules that yield improved technical performance metrics such as higher reward per unit of computation. This demonstrates that the AI-driven system does not simply mimic human strategies but implements its own machine-learned prompt construction rules that improve machine operation.

The user, through the terminal, can select among multiple modes or templates offered by the server, such as “short-form social ad,” “email subject line,” or “long-form description.” For each mode, the server uses different prompt composition rules and generation parameters. The reinforcement learning algorithm maintains separate or shared policies across modes, and the server updates them based on mode-specific evaluation indicators. This modular structure of prompt and parameter policies contributes to better reuse of learned knowledge, as well as to more stable and faster adaptation for new campaigns.

By configuring the system as described, the server, terminal, and user cooperate in a manner that improves computer technology itself: data is structured and normalized, prompt sentences are machine-optimized, generation parameters are automatically tuned, and a feedback loop based on reinforcement learning continually adapts internal parameters. This combination results in a system that is capable of technically efficient, high-quality generation and distribution of promotional texts with reduced computational and communication costs, which could not be readily achieved through manual human operations or simple automation without the described specific data structures, algorithms, and control flows.

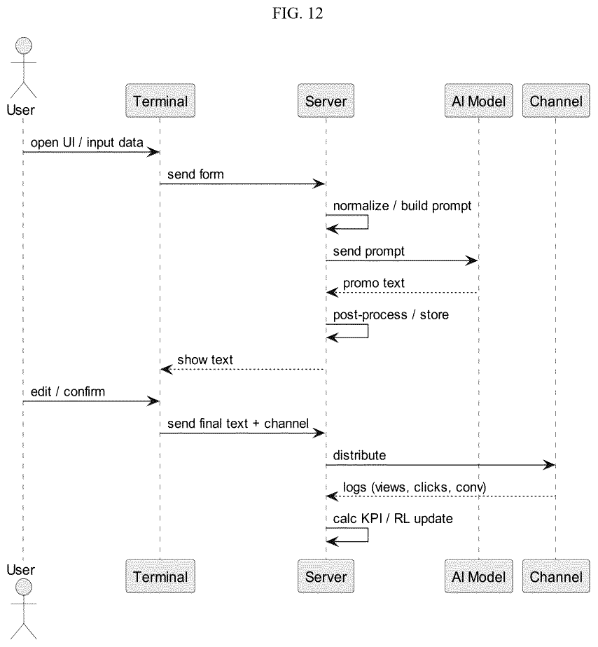

The following describes the processing flow using FIG. 12.

### Step 1:

User operates the terminal to open an application screen provided by the server.

User inputs, into separate text fields on the terminal, at least a promotion target, an appeal subject, a point to be emphasized, and an evaluation indicator.

Input: Raw natural-language strings typed by the user in the UI fields.

Output: Structured form data inside the terminal (for example, a key-value mapping with fields “target,” “appeal_item,” “selling point,” and “kpi”).

Terminal converts the UI field values into an internal data structure, associates each text with a field name, and prepares the data for transmission.

### Step 2:

Terminal transmits the structured form data to the server via a communication network.

Input: Structured form data held in the terminal's memory.

Output: HTTP request payload containing the form data encoded as structured text (for example, in JSON or similar key-value format) sent to the server.

Terminal serializes the internal data structure into a text-based representation, sets appropriate headers, and sends a network request to a predefined endpoint of the server.

### Step 3:

Server receives the network request and parses the structured form data.

Input: HTTP request payload including the structured form data sent by the terminal.

Output: In-memory representation of input fields stored as structured records in the server.

Server invokes a request handler to decode the payload, extract values for the promotion target, appeal subject, point to be emphasized, and evaluation indicator, and store them in a data structure such as a record or object with named attributes.

### Step 4:

Server normalizes the input text data and generates generation data.

Input: Parsed raw text fields from the user (target, appeal_item, selling point, kpi).

Output: Normalized generation data including cleaned and standardized text values.

Server calls string-processing functions to trim whitespace, convert character encodings to a unified format, remove control characters, unify numerical expressions (for example, convert “5 percent” and “5%” into a canonical representation), and standardize punctuation.

Server stores both raw and normalized values in a structured record so that subsequent processing uses the normalized generation data.

### Step 5:

Server constructs a prompt sentence for a generative AI model based on the generation data.

Input: Normalized generation data containing labeled fields and standardized values.

Output: A prompt sentence expressed as a single or multi-line text block ready for submission to a generative AI model.

Server applies prompt composition rules that define how to order fields and how to embed them into human-readable labels and instruction text.

Server, for example, concatenates text as follows:
Target: people interested in eco-friendly products
Appeal item: a new reusable eco bag
Selling point: supports a sustainable lifestyle and is easy to carry
KPI: click-through rate 5% on SNS ads

Based on this information, generate a short, persuasive promotional text that encourages users to click. Use clear and engaging language, and include a call to action.

Server thus converts structured fields into a prompt sentence string that encodes both data and generation instructions.

### Step 6:

Server selects generation conditions and prepares a request to the generative AI model.

Input: Constructed prompt sentence and current internal parameters for generation (such as temperature, output length limit, and occurrence frequency control).

Output: Model request data specifying the prompt sentence and generation conditions.

Server retrieves internal policy parameters learned via reinforcement learning or configured by an administrator, computes concrete values for temperature, maximum output tokens, and frequency penalty, and combines them with the prompt sentence into a request data structure.

Server sets these values so that they align with the target evaluation indicator (for example, a lower temperature for high-precision campaigns or a higher temperature for exploratory campaigns).

### Step 7:

Server transmits the model request to the generative AI model and initiates text generation.

Input: Model request data containing the prompt sentence and generation parameters.

Output: Model response data including generated token sequences that represent a preliminary promotional text.

Server sends the request through the communication interface to either an external model hosting service or a local inference engine, and then waits for a response.

The generative AI model internally tokenizes the prompt sentence, applies its neural network layers, computes probability distributions over tokens at each position, and samples tokens according to the provided generation conditions until an end-of-sequence condition or length limit is reached.

### Step 8:

Server decodes and extracts promotional text data from the model response.

Input: Model response data that includes generated tokens or generated text segments.

Output: Initial promotional text data in plain-text form.

Server converts token IDs into characters according to a vocabulary mapping, concatenates characters into strings, and if necessary merges multiple text segments into a single promotional text.

Server isolates the main generated text portion, ignoring metadata or auxiliary fields, and places it into a text variable for further processing.

### Step 9:

Server performs post-processing on the initial promotional text to produce a final promotional text.

Input: Initial promotional text data obtained from the generative AI model.

Output: Final promotional text that satisfies formatting and length constraints.

Server applies text-cleaning operations such as removal of phrases like “Here is your ad:” or trailing disclaimers using pattern matching rules.

Server enforces character or token length limits by computing the length of the text and truncating at suitable word boundaries if the text exceeds a configured maximum.

Server optionally corrects simple punctuation anomalies and standardizes quotation marks, then stores the resulting final promotional text as a field in a campaign record.

### Step 10:

Server transmits the final promotional text to the terminal for user review.

Input: Final promotional text and associated campaign identifier stored on the server.

Output: Response message to the terminal containing the final promotional text and metadata.

Server encapsulates the final promotional text and a campaign ID into a response structure, sends this data over the network to the terminal, and marks the campaign status as “awaiting user confirmation” in its storage.

### Step 11:

Terminal receives and displays the final promotional text to the user.

Input: Response message from the server containing the final promotional text.

Output: Rendered text on the terminal's display and editable content in UI components.

Terminal parses the response, inserts the text into a visible text field or text area, and updates the screen layout to show the generated promotional text along with control elements such as “Edit,” “Confirm,” and “Cancel” buttons.

Terminal maintains the displayed text in local memory, enabling user edits.

### Step 12:

User reviews and optionally edits the displayed final promotional text.

Input: Displayed final promotional text and interactive UI elements on the terminal.

Output: Confirmed promotional text as determined by the user.

User reads the text on the display and may modify portions of the text by typing, deleting, or rearranging words.

User then performs a confirmation action, such as pressing a “Confirm and Distribute” button, causing the terminal to finalize the text for submission.

### Step 13:

Terminal sends the confirmed promotional text and distribution settings to the server.

Input: User-confirmed text and user-selected distribution media (for example, email and social platform options) on the terminal.

Output: Request message to the server including the confirmed text and channel selections.

Terminal packages the confirmed text, campaign identifier, and selected distribution channels into a structured request and transmits it via the communication network to the server.

### Step 14:

Server stores the confirmed final promotional text and distribution configuration.

Input: Request containing confirmed text and distribution channel information.

Output: Updated campaign record in storage associating the final text with distribution metadata.

Server locates the corresponding campaign entry using the campaign identifier, updates fields for final_text, selected_channels, and status, and writes these changes to the storage device.

Server thereby establishes a persistent mapping between the final promotional text and its intended delivery configuration.

### Step 15:

Server formats and transmits the final promotional text to external information distribution platforms.

Input: Campaign record including final promotional text and selected distribution channels.

Output: Platform-specific payloads sent to external services for content distribution.

Server generates API payloads for each selected platform, embedding the final promotional text, tracking identifiers, and any required metadata such as subject lines, recipient lists, or audience segments.

Server uses the communication interface to send these payloads through connection application interfaces of the external platforms, and records returned identifiers (such as message IDs or post IDs) in the campaign record.

### Step 16:

Server acquires user behavior log data from external platforms and analysis systems.

Input: Platform message identifiers, campaign identifiers, and time range information stored in the server.

Output: Retrieved log data containing metrics such as impressions, clicks, and conversions linked to campaigns.

Server sends queries or scheduled requests to external information distribution platforms or access analysis platforms, referencing message IDs and time windows.

Server parses returned data, extracts numerical metrics, and attaches these values to the corresponding campaign and message entries in the storage device.

### Step 17:

Server computes evaluation values corresponding to evaluation indicators using log data.

Input: Raw log metrics (for example, number of displays, number of clicks, number of conversions) associated with each campaign and message.

Output: Evaluation values such as click-through rate and conversion rate recorded in structured form.

Server performs arithmetic operations such as division and aggregation, for instance computing click-through rate as clicks divided by impressions and conversion rate as conversions divided by either clicks or impressions.

Server stores these computed values as evaluation attributes within the campaign record, indexed by time series units and campaign units.

### Step 18:

Server updates reinforcement learning state using evaluation values as reward signals.

Input: Evaluation values, stored representation of prompt composition actions and generation parameter settings for each campaign.

Output: Updated internal policy parameters controlling prompt sentence formation and generation conditions.

Server encodes each campaign's context (for example, encoded target and appeal subject) and action (for example, selected prompt structure and parameters) into feature vectors.

Server applies a reinforcement learning algorithm, such as a contextual bandit or policy gradient method, to adjust internal parameter vectors that map from context to preferred actions.

Server computes gradients of a loss function based on negative reward and updates its policy parameters in memory or on the storage device, recording the update history.

### Step 19:

Server applies updated policy parameters in constructing future prompt sentences and selecting generation conditions.

Input: New generation data from subsequent user inputs and updated policy parameters from the reinforcement learning component.

Output: Modified prompt sentences and adapted generation parameter values for subsequent calls to the generative AI model.

Server consults the learned policy to choose which labels, ordering, length constraints, and tone instructions to include in the next prompt sentence, and to calculate numerical values for temperature, output length limit, and occurrence frequency control.

Server thereby modifies the pattern and configuration of subsequent model requests, aiming to produce promotional texts that are more likely to achieve higher evaluation indicators based on previously observed behavior.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented systems for generating promotional text using machine learning or generative models suffer from several technical limitations in how they process, represent, and exploit feedback data. Typical systems simply take user-provided marketing parameters as static inputs and invoke a text generation engine once, without a closed-loop mechanism that structurally integrates measured user reactions back into the generation pipeline. As a result, the underlying computing components do not effectively adapt their internal generation policies, prompt constructions, or model parameters based on real-world performance, and thus cannot systematically improve the quality of generated promotional text over time.

In many existing implementations, tracking of user reactions such as openings, selections, and transitions is handled as an external analytics process, loosely coupled to the text generation system. The computing architecture therefore does not treat reaction data as structured state information for learning and optimization, and the text generation logic remains largely heuristic or rule-based. This separation leads to inefficient use of processing resources, fragmented data flows between storage and processing units, and an inability of the processor to automatically refine its own prompt sentences or generative conditions in a principled, algorithmic manner. Consequently, the system cannot reliably converge toward higher-performing promotional texts for specific user segments and appeal patterns.

Furthermore, conventional generative systems typically expose only a one-shot, black-box interface to users, where the user simply inputs basic marketing content and receives a generated text. Users cannot easily leverage the internal performance history of the system in an interactive manner, nor can the system dynamically adapt prompt construction based on reinforcement learning from prior campaigns. This limits the technical capability of the computing system to support iterative, data-driven optimization using reinforcement learning algorithms that operate directly on event-level reaction data stored in a unified information storage device.

There is therefore a need for an improved computer-implemented system that: (i) tightly integrates input of segment, promotion target, and key appeal information with automated construction of prompt sentences for a generative AI model; (ii) transforms user reaction events into structured state and reward signals for a reinforcement learning algorithm; and (iii) updates internal prompt generation policies and generative condition parameters in a closed loop, so that the processor can automatically improve subsequent promotional text candidates as a function of measured performance. Such a system would constitute a technical improvement in how computing devices orchestrate data collection, storage, text generation, tracking, and learning, thereby enhancing the accuracy, adaptability, and efficiency of computer-based promotional text generation.

The specific processing by the specific processing unit 290 of the data processing device 12 in Example 2 is realized by the following means.

The present invention provides a server comprising a processor and a storage device, the processor being configured to provide, on a user interface of an information input/output device, a user screen for input of segment information, promotion target information, key appeal information, and evaluation metric information by a user, to receive, via a communication circuit, the segment information, the promotion target information, the key appeal information, and the evaluation metric information input from the user screen and store the received information as structured data in the storage device, to generate, based on the information stored in the storage device and execution history information including past campaign results, a prompt sentence in a natural language for instructing a generative AI model to generate a promotional text, to provide the generated prompt sentence to the generative AI model, cause the generative AI model to automatically generate a promotional text candidate optimized for the segment information and the key appeal information, and store a generation result of the promotional text candidate in association with the information stored in the storage device, to convert the promotional text candidate stored in the storage device into distribution data in a transmission format for an electronic communication medium or a display medium and transmit the distribution data to a message delivery apparatus or an advertisement delivery apparatus, to acquire, from a measurement program or an analysis service, user reaction data corresponding to an opening operation, a selection operation, or a transition operation performed after the promotional text candidate is delivered, by using identification information, a tracking resource identifier, or a tracking image included in the distribution data, and accumulate the acquired user reaction data as event data in the storage device, to aggregate the accumulated event data to calculate a performance index value corresponding to the evaluation metric information, define a reward value based on the performance index value, and execute a reinforcement learning algorithm that receives, as a state, feature information representing the segment information, the promotion target information, the key appeal information, and the promotional text candidate, thereby updating at least one of a generation policy for the prompt sentence and a generation condition parameter supplied to the generative AI model, to automatically improve contents of a subsequently generated promotional text candidate by using the updated generation policy for the prompt sentence or the updated generation condition parameter, and to accept, for the generative AI model, an arbitrary prompt sentence created by the user and present, on the user screen, an improvement proposal of a promotion strategy or an additional promotional text proposal output by the generative AI model based on the arbitrary prompt sentence. This enables a closed-loop, computer-implemented optimization process in which the server systematically transforms raw reaction events into structured learning signals, directly adjusts prompt construction and model conditions at the processor level, and thereby improves the technical performance, adaptability, and efficiency of promotional text generation across successive campaigns.

The term “system” refers to a combination of hardware and software components including at least one processor and at least one storage device configured to execute the functions described in the claims.

The term “processor” refers to one or more hardware processing units, such as a central processing unit or an accelerator, configured to execute instructions and perform the operations recited in the claims.

The term “storage device” refers to one or more non-transitory computer-readable media, such as a semiconductor memory, a magnetic storage device, or an optical storage device, configured to store data, models, rules, and program instructions.

The term “communication circuit” refers to hardware and software components that enable data transmission between the system and external devices or services over a wired or wireless communication network.

The term “information input/output device” refers to any device having an input/output interface, such as a terminal, a client device, or a user terminal, through which a user can input information to and receive information from the system.

The term “user interface” refers to a logical interface, such as a graphical user interface or a web interface, presented on an information input/output device to enable user interaction with the system.

The term “user screen” refers to one or more display screens or views of the user interface configured to receive input from a user and present output from the system.

The term “segment information” refers to information indicating a target group or category of recipients for promotional content, including demographic information, behavioral information, preference information, or any combination thereof.

The term “promotion target information” refers to information indicating a subject of promotion, such as a product, a service, or an offering to be advertised or marketed.

The term “key appeal information” refers to information indicating main features, advantages, or selling points that are to be emphasized in a promotional text.

The term “evaluation metric information” refers to information specifying one or more quantitative or qualitative criteria used to evaluate performance of a promotional text, such as an open rate, a click-through rate, a conversion rate, or any other performance index.

The term “structured data” refers to data stored in a predefined format or schema, such as records, fields, or entries, that can be programmatically accessed, queried, and processed by the system.

The term “execution history information” refers to information indicating past operation results of the system, including previous campaigns, generated promotional texts, associated reaction data, and calculated performance indices.

The term “prompt sentence” refers to a natural language instruction or query provided as input to a generative AI model for controlling or guiding generation of a promotional text or other output.

The term “generative AI model” refers to a trained machine learning model configured to generate natural language text or other content based on an input prompt sentence and associated conditions.

The term “promotional text” refers to text content intended to promote, advertise, or market a promotion target to a segment, including subject lines, body texts, taglines, or other marketing messages.

The term “promotional text candidate” refers to a specific instance of promotional text generated by the generative AI model based on a prompt sentence and related input information.

The term “distribution data” refers to data including at least part of a promotional text candidate and related information formatted for transmission through a communication medium, such as an electronic message format or a network advertisement format.

The term “electronic communication medium” refers to a medium for transmitting data electronically, including electronic mail, messaging systems, or other digital communication channels.

The term “display medium” refers to any medium or environment in which visual information is presented, including display screens, web pages, or application screens.

The term “message delivery apparatus” refers to a device, system, or service configured to distribute electronic messages containing promotional texts to recipients.

The term “advertisement delivery apparatus” refers to a device, system, or service configured to distribute advertisements, including network advertisements, to user terminals or display media.

The term “identification information” refers to data used to distinguish or identify campaigns, messages, users, or events, such as identifiers, codes, or tags embedded in distribution data.

The term “tracking resource identifier” refers to a resource locator or reference, such as a URL or similar identifier, that is used to detect or record user interactions with a promotional text.

The term “tracking image” refers to an image resource, such as a small or invisible image, embedded in distribution data to detect loading events and thereby infer user actions such as message openings.

The term “user reaction data” refers to data indicating user interactions with a promotional text candidate, including opening operations, selection operations, transition operations, or other interaction events.

The term “event data” refers to structured records stored in the storage device representing individual or aggregated user reactions or system events associated with promotional texts.

The term “performance index value” refers to a quantitative value computed from event data according to evaluation metric information, such as an open rate, a click-through rate, or a composite performance score.

The term “reward value” refers to a numerical value derived from a performance index value and used as a reward signal in a reinforcement learning algorithm.

The term “feature information” refers to numerical or categorical data representing characteristics of segment information, promotion target information, key appeal information, and a promotional text candidate, suitable for input to a learning algorithm.

The term “reinforcement learning algorithm” refers to a machine learning algorithm that updates parameters of a policy or value function based on states, actions, and reward values to improve future performance.

The term “generation policy for the prompt sentence” refers to rules, parameters, or models used by the processor to construct or modify a prompt sentence given input information and execution history information.

The term “generation condition parameter” refers to a parameter or set of parameters supplied to the generative AI model, such as control tokens, temperature values, style indicators, or other configuration values affecting generation behavior.

The term “generation rules” refers to stored logical conditions or mappings that determine selection of at least one of wording style, text length, structural element, or appeal pattern based on a combination of segment information, promotion target information, and key appeal information.

The term “wording style” refers to linguistic characteristics of text, including tone, formality level, sentiment, or rhetorical style.

The term “text length” refers to a measure of the amount of content in a text, such as a number of characters, words, or sentences.

The term “structural element” refers to a component of a promotional text, such as a subject line, heading, paragraph, bullet list, call-to-action, or similar element.

The term “appeal pattern” refers to a configuration or combination of key appeal information and rhetorical techniques used to emphasize features or benefits in a promotional text.

The term “electronic message format” refers to a data format suitable for electronic messages, including headers, body content, and optionally attachments or markup.

The term “network advertisement format” refers to a data format suitable for presenting advertisements through a network environment, such as banner formats, native ad formats, or feed-based ad formats.

The term “measurement program” refers to software executed on a computing device that collects or provides user reaction data associated with distributed promotional texts.

The term “analysis service” refers to a service or system that aggregates, analyzes, or exposes user reaction data or performance metrics through an interface accessible by the processor.

The term “subsequently generated promotional text candidate” refers to a promotional text candidate that is generated after execution of the reinforcement learning algorithm and updating of at least one of the generation policy for the prompt sentence and the generation condition parameter.

The term “arbitrary prompt sentence created by the user” refers to a free-form natural language instruction or query input by a user through the user interface, without being constrained to a predetermined template, for use as input to the generative AI model.

In one embodiment, a server cooperates with one or more terminals and users to implement the claimed system. The server comprises a processor, a storage device, and a communication interface. The terminal comprises a display unit, an input unit, and a network communication unit. The user operates the terminal to provide marketing parameters and prompt sentences and to review generated promotional text and improvement proposals.

The server executes software components implemented, for example, using an application framework (such as a web application framework) and a machine learning framework (such as a deep learning framework). The server uses a database management system as the storage device. Examples of such frameworks and systems include an HTTP application server implemented with a general-purpose programming language runtime (for example, a runtime comparable to those of server-side scripting languages), a relational database management system such as a SQL-based engine, and a deep learning framework such as a tensor-based computation library. The server may deploy a generative AI model on an accelerator device such as a graphics processing unit.

The server provides, via the communication interface, a user interface to the terminal. The terminal displays a user screen that includes input fields for segment information, promotion target information, key appeal information, and evaluation metric information. The user operates the terminal to enter values into these fields. The terminal transmits the entered values to the server over a network such as a packet-switched communication network.

The server receives the entered segment information, promotion target information, key appeal information, and evaluation metric information. The server converts the received information into structured data objects and stores these objects as records in the storage device. The server may represent segment information as fields including age range, location, interests, and device type; promotion target information as fields including category, price range, and primary function; and key appeal information as fields including feature identifiers and benefit descriptors. The storage device may hold these records in tables with foreign key relationships, enabling efficient querying and aggregation.

The server configures the generative AI model as a neural network, for example, a transformer-based language model including a plurality of layers of self-attention blocks and feed-forward networks. Each layer may include multi-head attention sublayers, layer normalization sublayers, and position-wise feed-forward sublayers. The server stores model parameters, such as weight matrices of the attention and feed-forward sublayers, in the storage device or in a memory subsystem associated with an accelerator. The server configures hyperparameters such as a context length, a number of attention heads, an embedding dimension, and a sampling temperature.

The server generates a prompt sentence for the generative AI model by programmatically constructing a natural language instruction from the stored structured data. The server retrieves segment information, promotion target information, and key appeal information for a particular campaign identifier. The server transforms these fields into a textual description that the generative AI model can interpret as conditions for generating a promotional text.

For example, the server may generate a prompt sentence such as:

“You are a marketing copywriter. Create an email subject line and body for a promotional campaign. Target: college students in their 20s who often study at cafes. Product: a subscription for unlimited refill coffee. Selling points: low monthly price, unlimited refills, quiet study space. Optimize the content to improve email open rate and click-through rate. Use friendly and energetic wording.”

In another example, the server may generate a prompt sentence such as:

“Please propose three new email subject lines and body text variations to increase the open rate by 20% for women in their 30s in a metropolitan area who are interested in fitness and healthy food. The product is a low-sugar organic protein bar. Use friendly and motivational wording.”

The server can automatically modify the structure and content of the prompt sentence based on learned generation policies and generation rules stored in the storage device. These policies may encode decisions about wording style, length of the request, explicit enumeration of constraints, and desired output structure.

The server provides the constructed prompt sentence to the generative AI model. The generative AI model processes the prompt sentence by converting each token into an embedding vector, computing positional encodings, and propagating the token embeddings through the transformer layers. Within each layer, the model applies scaled dot-product attention, where attention scores are computed as a function of query, key, and value matrices. The server applies a non-linear activation function (for example, a rectified linear unit or a similar function) within the feed-forward sublayers. The server obtains output probabilities over vocabulary tokens and samples or decodes tokens to form a promotional text candidate sequence.

The server stores the generated promotional text candidate, including a subject line, body text, and optional call-to-action phrases, as structured data fields in the storage device. The server associates these fields with the underlying campaign identifier, segment information, and time-of-generation metadata. The storage device may index these records to enable rapid retrieval for subsequent analysis and reinforcement learning.

The terminal obtains the generated promotional text candidate from the server via the communication interface. The terminal displays the subject line and body text to the user. The user may choose to accept, modify, or discard the generated content. When the user edits the content, the terminal transmits the edited content back to the server, and the server updates the corresponding records in the storage device.

The server converts the final promotional text candidate into distribution data formatted for an electronic message format or a network advertisement format. For an electronic message format, the server constructs a structured document including headers (such as sender, recipient, subject) and a body encoded in a markup language that may include hyperlinks, images, and layout elements. For a network advertisement format, the server constructs data including a title, a description, an image reference, and click-through URLs.

The server embeds identification information, tracking resource identifiers, and tracking images into the distribution data. For example, the server may append a unique campaign identifier and a user-specific identifier to hyperlinks, and may insert a tracking image URL referencing a resource hosted by the server. The server stores mappings between these identifiers and the campaign records in tracking tables within the storage device.

The server transmits the distribution data to a message delivery apparatus or an advertisement delivery apparatus. The message delivery apparatus delivers the electronic messages to recipients, and the advertisement delivery apparatus displays the advertisements on display media such as web pages or application screens.

The server subsequently receives user reaction data via tracking endpoints. When a recipient opens an electronic message, the terminal of the recipient requests the tracking image from the server, and the server records an “open” event with associated identifiers and timestamps. When a recipient selects a link, the terminal of the recipient requests a tracking resource identifier from the server, and the server records a “click” event and performs a redirect to a destination resource. The server may additionally receive aggregated performance data from analysis services through an application programming interface.

The server stores each reaction event as event data in the storage device. The event data includes a campaign identifier, a user or session identifier, an event type (such as open, click, or transition), a timestamp, and any additional contextual attributes. The server stores the event data in event tables indexed by campaign identifier and time.

The server aggregates the event data to calculate performance index values corresponding to the evaluation metric information. For example, the server may count the number of sent messages, opened messages, and clicked links, and compute open rates and click-through rates as ratios. The server stores these performance index values in association with the campaign identifier and the generation configuration used to produce the promotional text candidate.

The server transforms the structured data and performance index values into feature information suitable for a reinforcement learning algorithm. The server may create a feature vector that includes numerical encodings of segment attributes (for example, age bucket, location bucket), promotion target attributes (for example, product category code), key appeal attributes (for example, binary flags indicating presence of certain appeal types), and text attributes (for example, subject length in tokens, sentiment score, presence of numerals). The server normalizes or scales these features to appropriate ranges.

The server defines a reward value based on one or more performance index values. For example, the server may compute a weighted sum of open rate and click-through rate, or may apply a non-linear transformation that penalizes underperforming campaigns. The server uses this reward value as a training signal in a reinforcement learning algorithm.

The server implements the reinforcement learning algorithm using a machine learning framework. In one embodiment, the server uses a contextual bandit or policy-gradient method in which the state corresponds to the feature information, the action corresponds to a selection of a prompt template or generation strategy, and the reward corresponds to the computed reward value.

The server stores policy parameters, such as weights of a linear or neural function approximator, in the storage device.

The server executes a training loop in which it updates the policy parameters using gradient-based optimization. The server computes gradients of an objective function, for example, a function representing expected reward, with respect to the policy parameters. The server applies an optimization algorithm such as stochastic gradient descent or an adaptive method to update the parameters. The error function may represent the difference between observed reward and predicted reward for a chosen action. The server may use techniques such as exploration bonuses or regularization to avoid overfitting to a narrow set of campaigns.

By updating the policy parameters, the server modifies the generation policy for the prompt sentence and generation condition parameters supplied to the generative AI model. For instance, the server may increase the probability of selecting a prompt pattern that instructs the model to generate shorter subject lines with explicit numerical benefits for a particular segment, if such pattern historically yields higher reward values. The server stores the updated generation rules and policies in the storage device as configuration records.

The server uses the updated generation policy and generation condition parameters when constructing prompt sentences for subsequent campaigns. Because the policy is trained from structured event data and reward values, the server is able to adapt prompt construction in a way that is not merely a static rule set or human-designed heuristic, but rather a data-driven mapping from campaign characteristics to prompt structure and generative conditions. This adaptation improves computational efficiency by reducing the need for repeated manual tuning and experimentation and by systematically steering the generative AI model toward configurations that achieve higher performance.

The technical effect of this design is that the server improves the internal operation of the computing system. The server reduces redundant exploration of low-performing text patterns by using learned policies, decreases the number of generative iterations required to reach effective promotional texts, and organizes reaction events in a structured manner that supports efficient aggregation and learning. The server thereby reduces processing time and memory usage for future campaigns, and improves prediction accuracy of which prompt and generation configuration will yield higher performance index values.

The server also accepts arbitrary prompt sentences created by the user via the terminal. The user may, for example, enter a prompt sentence such as:

“Analyze the last 10 campaigns targeting college students who study at cafes and explain which subject line patterns produced the highest open rates, then propose three new subject lines following those patterns.”

The server retrieves historical campaign and performance data from the storage device, computes pattern statistics such as average subject length, prevalence of certain keywords, or distribution of sentiment scores, and incorporates these statistics into an extended prompt sentence provided to the generative AI model. In this way, the system uses internal data representations and derived features that would be impractical for a human user to compute manually, and leverages them to guide text generation in a technically non-conventional manner.

The terminal displays the improvement proposals and additional promotional text proposals generated in response to user-provided prompt sentences. Because the server integrates model output with stored performance statistics and learned policies, the improvement proposals are not merely restatements of user inputs but are grounded in computed features and learned patterns specific to the system.

The described configuration goes beyond simple automation of human tasks. The server implements specific data structures (campaign records, event tables, feature vectors, and policy parameter records) and specific algorithmic flows (prompt construction, transformer-based generation, event logging, feature extraction, reward computation, and reinforcement learning updates) that cooperate to improve the way the computer generates and refines promotional texts. This architecture reduces latency in generating effective texts, increases accuracy in predicting high-performing configurations, and reduces error rates associated with relying on static templates.

In another embodiment, the server may use alternative neural architectures, such as recurrent neural networks or encoder-decoder models, instead of a transformer-based model. In such embodiments, the server still constructs prompt sentences as sequences of tokens, performs embedding and sequence processing, and updates generation condition parameters based on reinforcement learning driven by event-level reward signals.

In another embodiment, the server may apply different reinforcement learning algorithms, such as value-based methods or actor-critic methods. The server may represent the state-action value function with a neural network and update its parameters using a temporal-difference error. Despite such variants, the server continues to encode segment information, promotion target information, key appeal information, and text attributes into feature information, and to adjust generation policies and conditions based on computed reward values derived from actual user reaction data.

In another embodiment, the terminal may be implemented as a native application executing on a mobile communication device, and the user interface may employ native UI components to display and edit promotional texts and improvement proposals. The fundamental operations of the server, including structured storage of campaign data, construction of prompt sentences, management of generative AI model parameters, and execution of reinforcement learning algorithms, remain consistent with the foregoing description.

Through these embodiments and variations, the server, the terminal, and the user cooperate to realize a system in which generative AI model usage, prompt sentence construction, and reinforcement learning are integrated into a technically specific pipeline. This pipeline improves the functioning of the computer system itself in terms of processing speed, resource efficiency, prediction accuracy, and adaptability, and thereby provides a concrete technical implementation rather than a mere abstract idea.

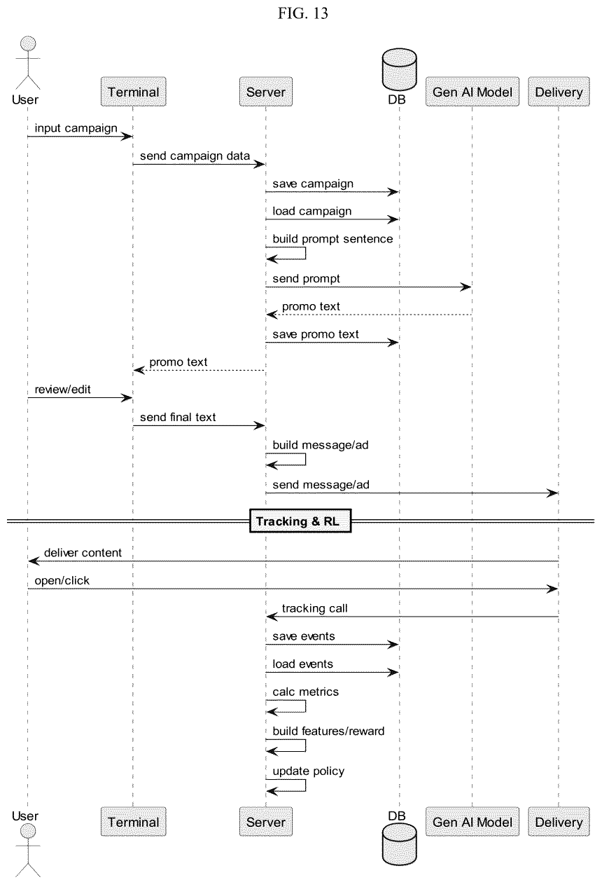

The following describes the processing flow using FIG. 13.

### Step 1:

The terminal presents a user interface for campaign input. The terminal receives, as input, interaction events from the user such as keystrokes and pointer events and converts these into textual values for segment information, promotion target information, key appeal information, and evaluation metric information. The terminal renders input fields on a display unit using graphical components and associates each field with an internal field identifier. The output of this step is a structured form object in the terminal's memory that contains the user-entered strings, for example, a segment description, a product description, and a list of key selling points.

### Step 2:

The user operates the terminal to enter campaign parameters. The user inputs, as input data, textual descriptions such as “Target: college students who study at cafes,” “Product: unlimited refill coffee subscription,” and one or more evaluation metrics such as “open rate” and “click-through rate.” The user triggers a submission operation by selecting a send button. The output of this step is a completed set of campaign parameters that the terminal is ready to transmit to the server.

### Step 3:

The terminal transmits the campaign parameters to the server. The terminal takes, as input, the structured form object created in Step 1 and the submission event created in Step 2, serializes the campaign parameters into a machine-readable message, and sends the message over a network via a communication protocol. During this data processing, the terminal maps each field identifier to a key string and each user-entered value to a corresponding value string, and encapsulates them into a request payload. The output of this step is a network request containing the campaign parameters delivered to the server's communication interface.

### Step 4:

The server receives and validates the campaign parameters. The server takes, as input, the network request from the terminal, parses the payload to extract segment information, promotion target information, key appeal information, and evaluation metric information, and performs validation checks. The server performs data processing operations such as verifying that required fields are present, that evaluation metrics belong to a predefined set, and that string lengths are within allowed limits. The server creates an internal campaign record object containing normalized values, assigns a unique campaign identifier, and stores this record in the storage device using a database engine. The output of this step is a persistent campaign record with a unique identifier stored in the database.

### Step 5:

The server prepares structured data for prompt construction. The server takes, as input, the stored campaign record retrieved from the storage device by the unique campaign identifier, and optionally additional execution history information such as past performance for similar segments. The server performs data processing operations including field normalization, such as converting text to canonical case, mapping human-readable evaluation metric names to internal metric codes, and constructing a feature summary of the segment and key appeals. The output of this step is a structured context object that encodes the campaign conditions required for constructing a prompt sentence.

### Step 6:

The server constructs a prompt sentence for the generative AI model. The server takes, as input, the structured context object from Step 5 and applies a prompt generation policy stored in the storage device. The server concatenates fixed template fragments with variable elements derived from the context object, such as segment descriptions, product attributes, and key appeals, and inserts explicit optimization goals aligned with the evaluation metric information. The server may also insert formatting markers that indicate desired output structure, such as “Subject:” and “Body:”. The data processing here is string assembly and token ordering based on rule selection and policy parameters.

The output of this step is a complete prompt sentence in natural language ready to be provided to the generative AI model.

### Step 7:

The server configures generation conditions and calls the generative AI model. The server takes, as input, the constructed prompt sentence and configuration parameters such as maximum token length, decoding temperature, and top-k or top-p sampling thresholds. The server encodes the prompt sentence into token identifiers using a tokenizer associated with the generative AI model, then transmits these token identifiers and the configuration parameters to a neural network execution engine running on processing hardware such as a processor or an accelerator. The data processing includes mapping characters to tokens and formatting the sequence into tensor structures. The output of this step is a model invocation request containing encoded input and model settings.

### Step 8:

The server generates a promotional text candidate using the generative AI model. The server receives, as input, output token probability distributions from the neural network execution engine, one step at a time. At each generation step, the server performs numerical computations to convert logits to probabilities (for example, using a softmax operation), samples or selects the next token according to the configured decoding algorithm, and appends the selected token to the output sequence. The server repeats this iterative data processing until an end-of-sequence condition is met or a maximum length is reached. The server then decodes the completed token sequence back into text strings. The output of this step is a promotional text candidate including, for example, a subject line and a body text generated by the generative AI model.

### Step 9:

The server stores the generated promotional text candidate. The server takes, as input, the generated subject and body text from Step 8 and the campaign identifier from Step 4. The server applies text normalization operations such as trimming whitespace, ensuring valid character encoding, and possibly computing auxiliary attributes such as text length or sentiment score. The server inserts or updates records in promotional text tables within the storage device, associating the promotional text candidate with the campaign identifier and timestamp. The output of this step is a stored promotional text record that can be retrieved for display or analysis.

### Step 10:

The terminal retrieves and displays the promotional text candidate. The terminal takes, as input, a response message from the server that includes the generated subject and body text. The terminal parses the message, maps the text fields to user interface components, and renders them on the display unit. The data processing consists of converting structured response fields to displayable text elements and updating the user interface state. The output of this step is a visual presentation of the promotional text candidate for the user.

### Step 11:

The user reviews and optionally edits the promotional text candidate. The user takes, as input, the displayed subject and body text, and may perform operations such as editing, adding or removing sentences, or adjusting tone. The user's actions generate updated text content as input to the terminal. The terminal detects these changes, updates its internal representation of the subject and body, and when the user confirms the edits, the terminal transmits the edited text to the server. The output of this step is edited promotional text that reflects user modifications and is ready for finalization and distribution.

### Step 12:

The server formats the promotional text candidate for distribution. The server takes, as input, the final version of the promotional text (either generated or edited) and the campaign parameters stored earlier. The server performs data processing to embed the text into a distribution template, for example, constructing an electronic message with headers and a body, or constructing an advertisement unit with title, description, and link. The server also generates tracking identifiers and tracking images, and inserts corresponding resource locators into hyperlinks and image tags. The output of this step is distribution data formatted for an electronic communication medium or a display medium, containing both content and tracking elements.

### Step 13:

The server transmits the distribution data to a delivery apparatus. The server takes, as input, the formatted distribution data from Step 12 and destination parameters such as recipient groups or placement channels. The server communicates with a message delivery apparatus or an advertisement delivery apparatus by converting the distribution data into a protocol-specific request and sending it through the communication interface. The server may perform batch scheduling or throttling to manage transmission load. The output of this step is successful handoff of distribution data to external delivery infrastructure, resulting in actual delivery to recipients.

### Step 14:

The server collects user reaction data via tracking endpoints. The server takes, as input, incoming network requests generated when recipient terminals load tracking images or follow tracking links.

The server parses each request to extract identifiers such as campaign identifier, recipient identifier, and link identifier, and classifies the event type as an open, click, or transition. The server timestamps each event and stores it as event data in the storage device. The data processing includes mapping raw request parameters to structured event records and performing basic validation, such as ignoring duplicated or malformed events. The output of this step is a set of stored event records representing user reactions to delivered promotional texts.

### Step 15:

The server aggregates event data and computes performance index values. The server takes, as input, the event records stored in the storage device and campaign metadata such as number of messages sent or impressions served. The server performs aggregation operations, grouping events by campaign identifier and event type, and counting occurrences. The server then computes evaluation metrics such as open rate and click-through rate by dividing counts of specific event types by the number of delivered messages or impressions. The server stores these computed performance index values in performance tables associated with each campaign. The output of this step is a set of numerical performance index values per campaign.

### Step 16:

The server constructs feature information and reward values for reinforcement learning. The server takes, as input, the campaign parameters, the attributes of the promotional text candidate (for example, subject length, presence of numbers, sentiment score), and the performance index values from Step 15. The server encodes these data into a feature vector by assigning numerical or categorical codes to each attribute, normalizing values to defined ranges, and concatenating them into a fixed-length representation. The server computes a reward value using a predefined function, for example, a weighted combination of the performance metrics. The output of this step is a state representation (feature vector) and a corresponding scalar reward suitable for input to a reinforcement learning algorithm.

### Step 17:

The server updates reinforcement learning policy parameters. The server takes, as input, the feature vector, a recorded action representing the generation policy or prompt template used for the campaign, and the reward value from Step 16. The server computes a prediction of expected reward under the current policy, compares this prediction with the observed reward, and derives an error signal. Using this error signal, the server calculates gradients of a policy objective function with respect to policy parameters, and updates the parameters according to an optimization rule such as gradient descent. The data processing is numerical and includes matrix-vector multiplications and parameter adjustments. The output of this step is an updated set of policy parameters stored in the storage device.

### Step 18:

The server updates generation policies and generation condition parameters. The server takes, as input, the updated policy parameters from Step 17 and current generation rules stored in configuration tables. The server computes, for each combination of segment information, promotion target information, and key appeal information, which prompt construction rules and generation condition parameters (for example, temperature or maximum length) are predicted to yield higher reward. The server then updates the generation rules, for example by adjusting probability distributions over prompt templates or by modifying threshold values for selecting wording styles. The output of this step is a revised set of generation policies and condition parameters that will govern subsequent prompt sentence construction.

### Step 19:

The server constructs improved prompt sentences for future campaigns. The server takes, as input, new campaign parameters from the storage device and the updated generation policies from Step 18. The server selects prompt templates and configuration values according to the learned policy, then assembles prompt sentences that incorporate specific instructions known to correlate with higher performance for similar segments. The data processing mirrors Step 6 but uses updated policy-driven decisions when choosing wording patterns and structural constraints. The output of this step is a set of improved prompt sentences that, when provided to the generative AI model, are expected to yield more effective promotional text candidates.

### Step 20:

The user interacts with the generative AI model using arbitrary prompt sentences. The user takes, as input, observations of system performance, displayed reports, and campaign goals, and manually composes a free-form prompt sentence such as “Please suggest five new subject lines to increase click-through rate by 15% for college students who study at cafes.” The terminal collects this textual input and sends it to the server. The server may augment the user-provided prompt sentence with internal statistics or historical summaries before passing it to the generative AI model. The server then receives generated suggestions, stores them as recommendation records, and sends them to the terminal. The output of this step is a set of improvement proposals or additional promotional text proposals that the terminal displays for user selection and possible integration into future campaigns.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented systems for generating promotional text using a generative AI model generally treat the model as a static text generator. In such systems, a processor simply forwards user inputs as a loosely structured prompt to the generative AI model, receives a single text output, and displays it to the user. These approaches suffer from several technical limitations. First, the processor does not systematically transform heterogeneous input data (campaign parameters, performance indicators, user feedback) into a machine-interpretable representation that can be used to control the behavior of the generative AI model in a fine-grained manner. As a result, the prompt design logic is hard-coded, non-adaptive, and does not improve over time, leading to inefficient use of computational resources and suboptimal convergence of model behavior.

Second, existing systems lack an integrated feedback loop at the system level in which distribution-time reaction signals (such as opens, clicks, conversions) and emotion-related signals (such as sentiment or user emotional state inferred from text, image, or audio) are captured, normalized, correlated with specific prompt sentences and generated texts, and then fed back into a reinforcement learning algorithm that directly updates a policy governing prompt construction and text generation strategy. Without such a loop, the processor cannot automatically learn which combinations of prompt structure, tone, length, and emphasis yield higher performance indicators, and therefore repeatedly generates texts using suboptimal prompts, wasting network bandwidth, compute cycles, and storage on low-quality iterations.

Third, conventional systems typically treat emotion analysis, if present at all, as a separate analytics function that does not affect the low-level control flow of prompt generation. Emotion labels are not maintained as first-class contextual features linked to each generated text and associated performance metrics. Consequently, the processor cannot adapt the generative AI model's behavior to different emotional contexts, and cannot optimize the prompt generation policy to exploit correlations between emotion states and downstream performance indicators. This limits the system's ability to tailor generative outputs to dynamic user states and reduces the effectiveness of reinforcement learning updates.

Fourth, conventional architectures often handle campaign creation, distribution, tracking, and analysis as loosely coupled modules. There is no unified data model that ties together input feature data, prompt sentences, candidate texts, selected “effective” texts, distribution events, user reactions, emotion events, and learned policies. This fragmentation forces the processor to perform expensive ad-hoc data joins and manual parameter tuning, increasing processing latency, memory consumption, and implementation complexity, and making it difficult to scale the system or to deploy updated policies in a controlled and verifiable manner.

Accordingly, there is a need for a computer-implemented system in which the processor (i) structurally normalizes and enriches user input into feature data, including emotion type information, (ii) automatically constructs and stores versioned prompt sentences according to a learned, updatable policy, (iii) generates and evaluates multiple candidate promotional texts from an external generative AI model, (iv) distributes selected effective promotional texts with embedded tracking identifiers, (v) collects and aggregates performance and emotion data as evaluation result data, and (vi) applies a reinforcement learning algorithm to update a policy model and a prompt-generation mechanism so that subsequent prompts and generated texts are adaptively optimized. Such a system improves the functioning of the computer itself by providing a concrete feedback-driven control architecture for the generative AI model, reducing unnecessary computation and network traffic, and enabling more efficient, context-aware text generation at scale.

The specific processing by the specific processing unit 290 of the data processing device 12 in Application Example 2 is realized by the following means.

The present invention provides a server comprising a processor and a storage apparatus, the processor being configured to control an input/output apparatus including a display screen accessed by a terminal so that a user can input information including a target group, an offering object, emphasis items, performance indicators, and optional free-text information via an information input screen; to receive, via a communication line from the terminal, the input information and identification information corresponding to the input information, and store the input information as structured data in the storage apparatus; to perform character string normalization processing and feature extraction processing on the input information stored in the storage apparatus, and generate feature data including target group information, offering object information, emphasis item information, performance indicator information, and free-text information; to perform natural language processing and classification processing on the free-text information or on evaluation information acquired from the user, calculate emotion type information indicating an emotional state and confidence information of the emotion type information, and store the emotion type information in association with the feature data in the storage apparatus; to select an instruction template into which an explanatory text describing the target group, the offering object, the emphasis items, the performance indicators, and the emotional state is embedded, based on the feature data and the emotion type information, and automatically create a prompt sentence that instructs a generative AI model to generate a promotional text by inserting the feature data into predetermined positions in the instruction template; to transmit request data including the prompt sentence and model control parameters to an information processing apparatus that provides the generative AI model operating on an external arithmetic apparatus, and receive, from the generative AI model, a plurality of candidate promotional texts output in response to the prompt sentence; to perform evaluation processing on the plurality of candidate promotional texts based on at least one of length, phrase composition, presence or absence of prohibited terms, and a quality evaluation value, select at least one effective promotional text based on a result of the evaluation processing, and output the effective promotional text in a format presentable to the user via the input/output apparatus; to convert the effective promotional text into distribution data according to a predetermined distribution method, add tracking identification information to link information in the distribution data, transmit the distribution data to recipients via an electronic communication network, and store distribution history information relating to the distribution processing in the storage apparatus; to acquire, from an analysis information processing apparatus, user reaction information indicating at least one of opening, selection, transition, and outcome occurrence measured in correspondence with the distribution data and emotion type information at a time of the user reaction, and store the user reaction information as evaluation result data aggregated for each performance indicator in the storage apparatus; to subject historical data including the evaluation result data, the emotion type information, the prompt sentence, and the candidate promotional texts to preprocessing as learning data, to apply a reinforcement learning algorithm using a machine learning library to learn a policy model that outputs at least one of a configuration method of the prompt sentence and a generation policy of the promotional text, and to update parameters of the policy model using, as a reward value, an evaluation value based on the performance indicators; and to determine, dynamically and based on the updated policy model, at least one of template selection, tone designation, length designation, and structural designation for a prompt sentence to be generated subsequently, and adaptively optimize the prompt sentence input to the generative AI model. This enables the server to implement an integrated feedback-driven control loop in which normalized feature data and emotion type information are used to generate structured prompt sentences, multiple candidate texts are evaluated and tracked during real-world distribution, and reinforcement learning is applied on aggregated performance and emotion data to update a policy model and prompt-generation logic, thereby improving the efficiency, scalability, and context sensitivity of computer-implemented generative text processing.

The term “processor” refers to one or more hardware computation units, such as a central processing unit or a programmable logic device, configured to execute instructions for controlling input/output, data storage, communication, and machine learning operations of the system.

The term “storage apparatus” refers to one or more non-transitory computer-readable storage media, such as a magnetic disk, solid-state memory, or optical storage, configured to store structured data, feature data, emotion type information, prompt sentences, promotional texts, distribution history information, and learned model parameters.

The term “input/output apparatus” refers to a hardware and software combination including at least a display device and an input device, configured to present user interfaces and to receive user inputs, and operable in conjunction with a terminal.

The term “terminal” refers to an end-user computing device, such as a personal computer, a tablet, or a smartphone, configured to access the server via a communication network and to display user interfaces provided by the server.

The term “target group” refers to information defining a class of intended recipients for a promotional text, including, for example, demographic attributes, interest attributes, or behavioral attributes.

The term “offering object” refers to information identifying goods, services, or events for which a promotional text is to be generated.

The term “emphasis items” refers to information specifying features, benefits, or aspects of the offering object that are to be highlighted or prioritized in the promotional text.

The term “performance indicators” refers to quantitative or qualitative metrics used to evaluate performance of a promotional text, including, for example, open rate, click-through rate, transition rate, conversion rate, or other outcome-related measures.

The term “free-text information” refers to arbitrary textual content input by a user that is not restricted to predefined categories, and that may include instructions, comments, or descriptions relevant to a campaign.

The term “structured data” refers to data arranged according to a predefined schema, including fields for target group information, offering object information, emphasis item information, performance indicator information, and free-text information.

The term “feature data” refers to data derived from input information through normalization and feature extraction, including, for example, tokenized text, normalized strings, categorical encodings, and numerical representations of campaign parameters.

The term “character string normalization processing” refers to processing that transforms textual data into a canonical form, including at least one of lowercasing, whitespace trimming, removal of control characters, or standardization of punctuation.

The term “feature extraction processing” refers to processing that derives structured features from raw input information, including, for example, keyword extraction, tokenization, part-of-speech tagging, or generation of vector representations.

The term “evaluation information” refers to data representing assessments or feedback from a user regarding a promotional text or campaign, including comments, ratings, or other explicit responses.

The term “natural language processing” refers to computational techniques for analyzing and transforming human language data, including tokenization, parsing, sentiment analysis, and embedding generation.

The term “classification processing” refers to a computation that assigns an input to one or more categories based on a trained model, such as assigning an emotion label to text.

The term “emotion type information” refers to data indicating a category of emotional state, such as positive, negative, neutral, or other emotional classifications, associated with user input or reactions.

The term “confidence information” refers to data representing a likelihood, probability, or reliability score that a particular emotion type information or classification result is correct.

The term “instruction template” refers to a predefined text pattern that includes fixed portions and placeholder portions, and that is used as a base form for constructing a prompt sentence.

The term “explanatory text” refers to narrative content embedded in an instruction template that describes the target group, the offering object, the emphasis items, the performance indicators, and optionally the emotional state.

The term “prompt sentence” refers to a natural-language instruction text provided to a generative AI model, specifying conditions and constraints for generation of a promotional text.

The term “generative AI model” refers to a trained machine learning model configured to generate text in response to an input prompt, based on learned statistical relationships in training data.

The term “model control parameters” refers to settings provided to a generative AI model, including, for example, maximum length, randomness control parameters, or decoding strategy parameters, that influence generation behavior.

The term “request data” refers to data transmitted from the processor to an information processing apparatus providing the generative AI model, the data including at least a prompt sentence and model control parameters.

The term “information processing apparatus” refers to one or more computing devices, external to the server, configured to provide access to a generative AI model and to return generated texts in response to request data.

The term “external arithmetic apparatus” refers to a computing resource, such as a remote server or cloud-based computation environment, on which the generative AI model executes.

The term “candidate promotional text” refers to a text output generated by the generative AI model in response to a prompt sentence, before selection of one or more texts as effective promotional texts.

The term “evaluation processing” refers to processing that measures properties of candidate promotional texts, including at least one of length, phrase composition, presence or absence of prohibited terms, and quality evaluation values.

The term “prohibited terms” refers to words or expressions that are not allowed to appear in a promotional text due to policy, legal, or other constraints.

The term “quality evaluation value” refers to a score that indicates an estimated suitability, compliance, or effectiveness of a candidate promotional text according to one or more criteria or learned models.

The term “effective promotional text” refers to at least one candidate promotional text selected as suitable for distribution based on evaluation processing.

The term “information input screen” refers to a graphical user interface displayed on the terminal by the input/output apparatus, through which a user enters campaign-related information.

The term “distribution data” refers to data that includes an effective promotional text integrated into a format suitable for transmission to recipients via an electronic communication network.

The term “distribution method” refers to a mode or channel of delivering distribution data to recipients, including, for example, electronic mail delivery, web page display, or posting to an online service.

The term “tracking identification information” refers to data embedded in distribution data that uniquely or semi-uniquely identifies the distribution data, a campaign, a user segment, or a particular instance of delivery for the purpose of measuring performance indicators.

The term “distribution history information” refers to records that describe when, how, and to whom distribution data was transmitted, including timestamps, recipient identifiers, and channel identifiers.

The term “electronic communication network” refers to any wired or wireless network used for electronic data transmission, including, for example, the Internet, local area networks, and mobile communication networks.

The term “analysis information processing apparatus” refers to one or more computing devices or services configured to collect, compute, and provide user reaction information and associated metrics related to distributed promotional texts.

The term “user reaction information” refers to data describing user interactions with distribution data, including events such as opening, selection, transition, or outcome occurrence.

The term “opening” refers to an event in which a recipient accesses or displays distribution data, such as opening an electronic mail message or viewing a screen containing a promotional text.

The term “selection” refers to an event in which a recipient explicitly chooses an element in the distribution data, such as clicking a link or activating a user interface element.

The term “transition” refers to an event in which a recipient moves from one resource to another resource, such as navigating from an electronic mail message to a linked web page.

The term “outcome occurrence” refers to an event representing completion of a desired action, such as completing a purchase, registering for a service, or performing another conversion event.

The term “evaluation result data” refers to aggregated data that represents measured values of performance indicators and associated user reaction information over time or across segments.

The term “historical data” refers to previously collected data including at least evaluation result data, emotion type information, prompt sentences, and candidate promotional texts stored in the storage apparatus.

The term “learning data” refers to data prepared from historical data for use in training or updating machine learning models, including normalization, feature extraction, and dataset partitioning.

The term “reinforcement learning algorithm” refers to a machine learning method that updates a policy model based on interactions between actions and rewards, so as to improve expected cumulative reward.

The term “machine learning library” refers to a software framework that provides functions for defining, training, and deploying machine learning models, including reinforcement learning models.

The term “policy model” refers to a machine learning model that outputs at least one of a configuration method of a prompt sentence and a generation policy of a promotional text, given feature data and context.

The term “reward value” refers to a numeric value derived from a performance indicator, used by a reinforcement learning algorithm to adjust parameters of a policy model.

The term “configuration method of the prompt sentence” refers to a rule or parameterization that determines at least one of a template to use, a tone, a length, or a structural arrangement for a prompt sentence.

The term “generation policy of the promotional text” refers to a strategy defining how a generative AI model should generate promotional text under various contexts, as encoded in a policy model.

The term “template selection” refers to a decision process that selects one instruction template from among multiple templates for constructing a prompt sentence.

The term “tone designation” refers to information indicating a desired style or attitude of a promotional text, such as enthusiastic, neutral, formal, or casual.

The term “length designation” refers to information specifying a desired size or extent of generated text, such as a short, medium, or long promotional text.

The term “structural designation” refers to information specifying an arrangement of sections or elements in a prompt sentence or promotional text, such as the order of presenting benefits and calls to action.

The term “adaptively optimize” refers to automatically adjusting a configuration based on learned parameters and observed feedback, so that performance indicators are improved over time.

The term “information display screen” refers to a layout or page presented on a terminal that displays content, including a promotional text or status information, to a user.

The term “electronic mail message” refers to a data unit transmitted via an electronic mail protocol, including a subject field, a body field, and optionally attachments or embedded resources.

The term “electronic advertisement slot” refers to a defined area within a digital resource, such as a web page or application view, that is designated for displaying a promotional text or advertisement.

The term “information distribution page” refers to a web page or analogous digital resource that presents promotional content, possibly including a promotional text, to recipients.

The term “social networking service post” refers to content formatted for publication on a social networking platform, including text and optionally multimedia elements.

The term “prompt generation model” refers to a machine learning model or rule base used to determine content and structure of a prompt sentence based on input feature data and context.

The term “template selection rule” refers to logic, either rule-based or learned, that maps feature data and context to a particular instruction template to be used in constructing a prompt sentence.

In one embodiment, a server includes a processor, a storage apparatus, and an input/output apparatus, and is connected to one or more terminals via an electronic communication network. The server executes program modules stored in the storage apparatus in order to implement acquisition of campaign information, generation of feature data and emotion type information, construction of a prompt sentence, interaction with a generative AI model, evaluation and selection of candidate promotional texts, distribution of effective promotional texts with tracking identifiers, collection and aggregation of reaction and emotion data, and reinforcement learning-based updating of a policy model and prompt-generation logic.

The server uses hardware such as one or more general-purpose central processing units, optional graphics processing units, and a non-transitory storage apparatus including solid-state memories and magnetic disks. The server uses general-purpose software components such as an operating system, a web server, and a relational database management system (for example, an implementation comparable to MySQL or PostgreSQL), together with application programs written in a high-level language such as a language comparable to Python. The terminal uses display hardware and input hardware (such as touch panels, keyboards, and pointing devices) and executes a web browser or a dedicated application to display user interfaces provided by the server.

The server controls the input/output apparatus to provide an information input screen to the terminal. The server causes the terminal to display fields for target group information, offering object information, emphasis item information, performance indicator information, and free-text information. The user operates the terminal to input these items as text or select them from lists. The terminal transmits the input information to the server using, for example, an HTTP or HTTPS protocol with a structured payload such as key-value pairs.

The server receives the input information and stores it as structured data in the storage apparatus. The server stores each item in a campaign table using a predefined schema including a campaign identifier, normalized strings, and references to auxiliary tables. The server then performs character string normalization processing. The server, for example, converts characters to a normalized case, deletes control characters, standardizes whitespace, and normalizes punctuation.

The server further performs feature extraction processing using a natural language processing library comparable to NLTK or spaCy. The server tokenizes the text into word units, assigns part-of-speech tags, and optionally creates numerical vector representations (embeddings) using a word-embedding model or a transformer-based encoder.

The server generates feature data including target group features, offering object features, emphasis item features, and performance indicator features. The server stores such feature data in a feature table indexed by the campaign identifier. The server thereby maintains a consistent data structure that is suitable for high-throughput processing and later use by a reinforcement learning module. This structural normalization reduces memory fragmentation and enables efficient indexed queries in the database, which in turn improves the overall processing speed of the system relative to naïve text-only storage.

The server performs emotion analysis on free-text information or evaluation information provided later by the user. The server uses a neural-network-based classifier built on a deep learning framework comparable to TensorFlow or another machine learning library. In one embodiment, the server uses a multi-layer neural network with an input layer receiving a sequence of token embeddings, several intermediate layers implemented as bidirectional recurrent layers or transformer self-attention layers, and an output layer producing logits over predefined emotion classes such as positive, negative, and neutral.

The server defines a loss function such as cross-entropy between predicted emotion class probabilities and ground truth labels, and trains the network using stochastic gradient descent or a variant thereof such as Adam. The server stores trained weights in the storage apparatus. During inference, the server computes a forward pass through this network for the user's free-text, obtains per-class probabilities, and selects the emotion type with the highest probability as the emotion type information. The server optionally stores the full vector of probabilities as confidence information. This explicit neural architecture and training process allows the server to classify emotions with higher precision than simple rule-based sentiment analysis, which leads to more accurate contextual adaptation during prompt generation.

The server associates the emotion type information with the feature data and stores both in the storage apparatus. Because the server uses a unified key structure based on the campaign identifier to link campaign records, feature data, and emotion type data, the server can retrieve complete contextual information for any campaign in a constant number of indexed queries. This data model reduces query complexity compared with conventional systems that keep campaign, performance, and emotion data in separate, loosely coupled systems.

The server uses a prompt-generation module to construct a prompt sentence for a generative AI model. The server defines multiple instruction templates as text patterns with placeholders. For example, the server may store a template such as:

“Create a promotional email text for [TARGET]. Emphasize [OFFERING] and highlight [EMPHASIS ITEMS]. Optimize for [PERFORMANCE INDICATORS]. Detected emotion: [EMOTION]. Use a tone that matches this emotion.”

The server selects an instruction template based on the campaign type and context. The server, for example, uses different templates for email campaigns, web advertisements, and social networking service posts. The server inserts the normalized target group, offering object, emphasis items, performance indicators, and emotion type into the placeholders of the selected template. The server thereby generates a concrete prompt sentence. In a specific example, the prompt sentence is:

“Create a promotional email text for people in their 20s. Emphasize a new skincare serum and highlight natural ingredients and gentle on sensitive skin. Optimize for click-through rate and conversion rate. Detected emotion: positive. Use a tone that matches this emotion.”

In another example, the server generates a prompt sentence:

“New promotional text is required for a new productivity application. The target group is office workers. The offering is a new productivity application that reduces task switching time. Emphasize time-saving benefits and ease of use. Optimize for sign-up rate. Use an enthusiastic but professional tone.”

The server records the generated prompt sentence in a prompt table together with a template identifier and a version number. The server's use of a structured template system and versioned prompt sentences allows systematic tracking of the relation between prompt variants and performance, which is not achievable by manual, ad hoc prompt writing.

The server transmits the prompt sentence and model control parameters to an information processing apparatus providing the generative AI model. The server uses a communication client to send an API request, including the prompt sentence as a sequence of tokens and parameters such as maximum token length, decoding temperature, and nucleus sampling threshold. The generative AI model, running on an external arithmetic apparatus, is implemented as a neural network with multiple transformer layers. Each transformer layer includes a multi-head self-attention block and a feed-forward block. The model is pre-trained on large corpora and optionally fine-tuned on promotional text data.

The generative AI model executes in the external arithmetic apparatus and performs an auto-regressive generation process that, given the prompt sentence, outputs candidate promotional texts token by token. The information processing apparatus returns one or more candidate promotional texts to the server. The server receives these candidate texts and stores them in a candidate text table in the storage apparatus, associating each candidate with the corresponding prompt identifier and model parameters.

The server evaluates each candidate promotional text using both rule-based filters and learned quality estimators. For example, the server computes the character count and token count as length metrics, checks for the presence of prohibited terms using a dictionary, and computes syntactic properties such as sentence count and average sentence length. The server also applies a secondary neural model trained to predict an expected performance score based on tokenized content. The server aggregates these metrics into a quality evaluation value. By filtering candidate texts using these objective criteria, the server prevents the distribution of texts that violate constraints or are likely to perform poorly, thus improving system-level precision.

The server selects at least one effective promotional text based on the evaluation results. The server marks the selected text as active in the storage apparatus and uses it to generate distribution data. For an email distribution method, the server constructs an electronic mail message with header fields and an HTML body containing the selected promotional text. The server embeds tracking identification information into all hyperlinks by appending unique query parameters. The server also embeds an invisible tracking element in the body to detect opening events.

The server sends the distribution data to recipients via an electronic communication network using a mail transfer component. The server records distribution history information such as recipient identifier, timestamp, channel, and tracking identifier. For web distributions, the server generates page templates in which the promotional text is inserted into a designated advertisement slot, and includes the tracking identifiers in links and tracking scripts.

The server later acquires user reaction information and associated emotion type information from an analysis information processing apparatus. The analysis apparatus collects events such as email opens, link selections, page transitions, and outcome occurrences (for example, purchases). The analysis apparatus may also provide aggregated metrics. The server retrieves event logs periodically, decodes tracking identifiers, and associates each event with the corresponding campaign and candidate promotional text by joining on the database keys.

The server aggregates user reaction information into evaluation result data for each performance indicator and each campaign or segment. The server stores the aggregated values, such as open rate and conversion rate, in a dedicated evaluation table. In some embodiments, the server integrates additional emotion events. The terminal, with the user's permission, captures image data via a camera and audio data via a microphone while the user views promotional content. The server receives this data and forwards it to an emotion analysis component that uses computer vision and acoustic analysis models to infer emotion type information. The server associates these emotion events with the corresponding exposure instances and stores them in the storage apparatus.

The server periodically executes a learning module that uses historical data including evaluation result data, emotion type information, prompt sentences, and candidate promotional texts as learning data for a policy model. The server uses a machine learning library comparable to TensorFlow or a similar framework to define and train the policy model. In one example, the server represents each campaign context as a feature vector that concatenates embeddings for the target group, the offering object, the emphasis items, the performance indicators, and emotion features, as well as summary statistics of prior performance. The server defines a policy network that maps this feature vector to parameters specifying a configuration method of the prompt sentence, including template selection, tone designation, length designation, and structural designation.

The server defines a reward value based on the observed performance indicators, for example a weighted sum of normalized click-through rate and conversion rate. The server uses a reinforcement learning algorithm such as policy gradient or actor-critic. The server computes gradients of the expected reward with respect to the policy network weights and updates the weights using gradient-based optimization. The server thus learns to prefer prompt configurations that historically led to higher performance for given contexts.

The server stores the updated policy model parameters in the storage apparatus and uses them in future prompt generation. When a new campaign is created, the server computes the context feature vector and passes it through the policy model to obtain a prediction of appropriate template, tone, length, and structure. The server then selects the corresponding instruction template and parameter values, and constructs a prompt sentence accordingly. Because the server uses a learned policy to drive prompt construction rather than a static rule set, the server can adapt its prompt sentences to evolving data patterns. This leads to improved performance metrics over time and prevents the system from being limited to a fixed, hand-tuned configuration.

This architecture improves computer technology in several ways. The server reduces the need for trial-and-error prompt design by a human operator, and instead formalizes prompt design as a machine learning problem solved by a reinforcement learning algorithm. The server thereby reduces the number of interactions required to converge to high-performing prompts and decreases network traffic to the generative AI model by avoiding low-quality prompt variants. The server's data structures and processing pipeline are designed to maximize cache locality and support incremental updates, which increases throughput and reduces latency under high campaign volumes.

Furthermore, the server uses emotion type information as a structured feature influencing both prompt generation and reinforcement learning. This is not a simple automation of human judgment, but a distinct computational approach where emotion probabilities are treated as numerical inputs to policy models. This leads to non-intuitive correlations between emotion and performance that can be exploited by the model and are difficult for human operators to discover manually. The server thereby achieves a reduction in prediction error relative to systems that ignore emotion or treat it only as an external report.

In another embodiment, the server uses an alternative neural architecture for the policy model, such as a transformer encoder operating on tokenized prompts and compressed campaign summaries. In this case, the server represents prompts and candidate texts as sequences and learns attentional patterns linking specific phrases to performance outcomes. The server uses this representation to modify template wording in non-obvious ways that yield improved performance. For example, based on learned attention patterns, the server may bias prompts to request that the generative AI model include a call-to-action in the first sentence for a subset of contexts where such structure has empirically yielded higher conversion rates.

In yet another embodiment, the server employs batch processing and mini-batch stochastic updates for the reinforcement learning algorithm to improve computational efficiency. The server groups multiple campaigns and their performance outcomes together, computes gradients using batched matrix operations on a graphics processing unit, and updates model parameters in fewer passes than a naive sample-by-sample approach. This reduces training time and power consumption while maintaining or improving model accuracy.

The terminal mainly functions as an interface and sensor device. The terminal receives user inputs and presents generated texts, and in some embodiments captures additional multimodal data. By off-loading computationally intensive tasks to the server and the external arithmetic apparatus, the system allows terminals with limited hardware to participate without performance degradation.

The user benefits from a system that not only automates text generation but also continually optimizes it by exploiting machine-specific operations such as high-dimensional feature extraction, gradient-based optimization, and policy adaptation. The described configurations and variations provide sufficient implementation detail for a person skilled in the art of computer systems and machine learning to design and implement the claimed system using available hardware and software components.

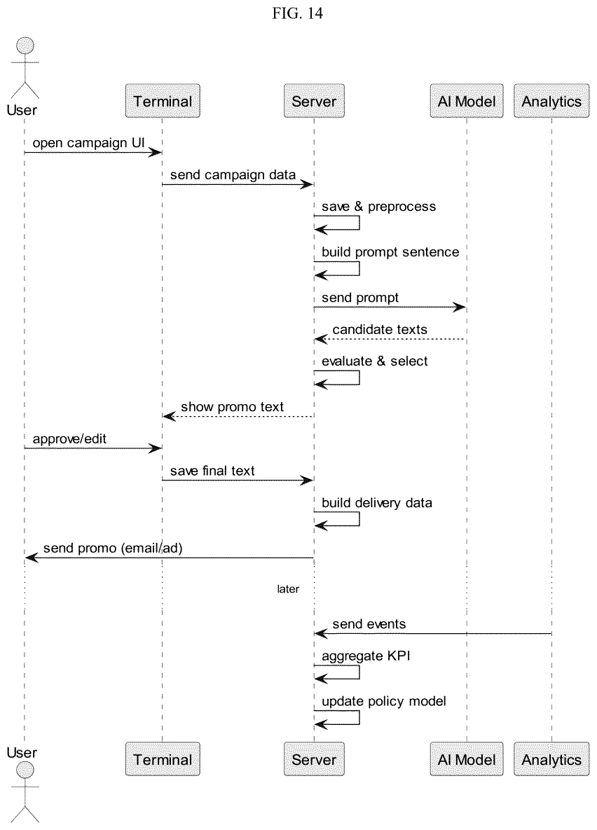

The following describes the processing flow using FIG. 14.

### Step 1:

User operates the terminal to access a campaign input screen provided by the server.

User inputs a target group, an offering object, emphasis items, performance indicators, and optional free-text notes into form fields on the terminal.

Terminal sends the input data as a structured request (input: raw campaign parameters in text form) to the server over a network.

Output of this step is a structured payload containing the campaign parameters and a user or session identifier.

### Step 2:

Server receives the structured payload from the terminal (input: raw campaign parameters and identifiers) via an application programming interface.

Server parses the payload, validates required fields, normalizes encodings, and maps each field to a predefined database schema.

Server writes the parsed and validated values to a campaign table in a storage apparatus, assigning a new campaign identifier.

Output of this step is a stored campaign record indexed by the campaign identifier.

### Step 3:

Server retrieves the stored campaign record from the storage apparatus (input: campaign identifier and corresponding raw text fields).

Server performs character string normalization (lowercasing, whitespace trimming, punctuation normalization) and tokenization on each text field.

Server applies feature extraction, such as keyword extraction and part-of-speech tagging, to derive numerical or categorical features.

Server stores the resulting feature vectors and normalized strings as feature data linked to the campaign identifier.

Output of this step is a feature data structure containing normalized campaign attributes.

### Step 4:

Server checks whether free-text notes or prior evaluation comments exist for the campaign (input: free-text fields associated with the campaign).

Server converts the free-text into a sequence of tokens or embeddings and feeds this sequence into an emotion classification model implemented as a neural network.

Server computes class probabilities over predefined emotion categories and selects the highest-probability category as emotion type information, retaining the probability vector as confidence information.

Server stores the emotion type information and confidence information linked to the campaign identifier in the storage apparatus.

Output of this step is emotion type information and confidence information associated with the campaign.

### Step 5:

Server assembles context information for prompt generation (input: feature data and emotion type information for the campaign).

Server selects an instruction template according to campaign type and context, and inserts the normalized target group, offering object, emphasis items, performance indicators, and emotion type into placeholder positions.

Server concatenates fixed template text and inserted values to build a complete prompt sentence in natural language.

Server stores the prompt sentence, together with a template identifier and campaign identifier, in a prompt table.

Output of this step is a fully constructed prompt sentence ready to be sent to a generative AI model.

### Step 6:

Server prepares a request to a generative AI model endpoint (input: prompt sentence and model control parameters such as maximum length and temperature).

Server serializes the prompt sentence and parameters into an API request format and transmits the request to an external information processing apparatus providing the generative AI model.

Server waits for a response in which the generative AI model returns one or more candidate promotional texts generated via auto-regressive decoding.

Server parses the response and stores the candidate promotional texts linked to the prompt and campaign identifiers in a candidate text table.

Output of this step is a set of candidate promotional texts associated with the campaign.

### Step 7:

Server loads all candidate promotional texts for the campaign (input: candidate texts and associated metadata from the storage apparatus).

Server computes evaluation metrics for each candidate, including length (character and token counts), phrase structure (sentence boundaries), presence of prohibited terms (via dictionary lookup), and quality scores (via a learned quality-estimation model).

Server aggregates these metrics into a composite evaluation score per candidate according to predefined weighting rules.

Server ranks the candidates by the composite score and selects at least one top-ranked candidate as an effective promotional text, marking it as active in the database.

Output of this step is an effective promotional text selected for distribution.

### Step 8:

Server makes the effective promotional text available through an interface for the terminal (input: campaign identifier and effective text identifier).

Terminal requests the effective promotional text by calling a server endpoint with the campaign identifier.

Server queries the storage apparatus, retrieves the effective promotional text and associated context, and sends them to the terminal.

Terminal displays the effective promotional text in an editable area so that the user can review or modify it.

Output of this step is a displayed promotional text on the terminal, optionally editable by the user.

### Step 9:

User reads the effective promotional text on the terminal and may adjust wording, tone, or length according to preferences (input: generated text displayed on the terminal).

User submits an approval command or a modified version of the text through the terminal interface. Terminal sends the approved or edited text back to the server with an indication of whether the text has been edited.

Server receives the final text, compares it with the original version to compute an edit distance or modification score, and stores the final text and modification flag linked to the campaign.

Output of this step is a final approved promotional text and associated modification information.

### Step 10:

Server prepares distribution data using the approved effective promotional text (input: final text, campaign parameters, and recipient segment definitions).

Server generates channel-specific formats, such as an email body with HTML markup or a web page fragment for an advertisement slot, inserting the text in the correct positions.

Server appends tracking identification information to all links and embeds tracking elements to detect opening events.

Server transmits the distribution data to recipients via the electronic communication network and records distribution history information including timestamps, channels, recipients, and tracking identifiers.

Output of this step is distributed promotional content and stored distribution history records.

### Step 11:

Server later receives or retrieves user reaction information from an analysis information processing apparatus (input: event logs containing tracking identifiers and event types such as open, click, transition, or conversion).

Server decodes tracking identifiers to map each event back to the corresponding campaign, recipient, and effective promotional text.

Server aggregates counts and rates for each performance indicator, such as open rate and click-through rate, over configured time windows and audience segments.

Server stores the aggregated metrics as evaluation result data in an evaluation table linked to campaign and text identifiers.

Output of this step is structured evaluation result data representing performance indicators for the promotional text.

### Step 12:

Server optionally acquires emotion events correlated with user reactions (input: emotion type information from text-based analysis or multimodal analysis, and reaction events with timestamps).

Server aligns emotion events with reaction events based on time and identifiers, and generates records that pair emotion type information with specific impressions and reactions.

Server stores these records in an emotion event table linked to the campaign and effective promotional text.

Output of this step is a set of emotion-reaction pairs that enrich performance data with emotional context.

### Step 13:

Server periodically retrieves historical records for learning (input: feature data, prompt sentences, candidate texts, evaluation result data, and emotion event data from multiple campaigns).

Server merges these records by campaign and text identifiers into a unified dataset, performs preprocessing such as normalization, encoding of categorical variables, and construction of context feature vectors.

Server splits the dataset into training and validation subsets and writes them into memory structures suitable for machine learning.

Output of this step is a prepared learning dataset containing context features, prompt configuration labels, and reward signals.

### Step 14:

Server loads or initializes a policy model for prompt configuration (input: learning dataset and initial model parameters).

Server defines a reinforcement learning objective in which actions correspond to prompt configuration decisions (template choice, tone, length, structure) and rewards correspond to performance indicators derived from evaluation result data.

Server applies a reinforcement learning algorithm to update model parameters, computing gradients of expected reward with respect to the parameters and adjusting them via an optimizer.

Server evaluates the updated model on validation data and, if performance improves, stores the new parameters in the storage apparatus.

Output of this step is an updated policy model that maps context features to prompt configuration decisions.

### Step 15:

Server uses the updated policy model in subsequent prompt generation cycles (input: context feature vector for a new or modified campaign and current policy model parameters).

Server feeds the context feature vector into the policy model and obtains outputs specifying a recommended instruction template, tone designation, length designation, and structural designation for the prompt sentence.

Server applies these outputs to select and parameterize an instruction template, constructs a new prompt sentence accordingly, and records the new configuration and its link to the policy state.

Server thereby adapts future prompt sentences and, in turn, influences the behavior of the generative AI model in a direction expected to improve performance indicators.

Output of this step is a policy-driven prompt sentence used as input to the generative AI model for new campaigns.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

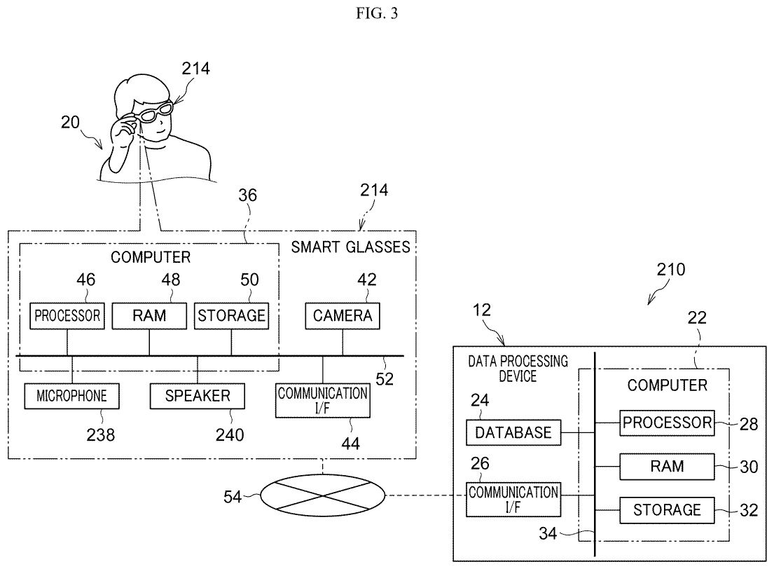

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

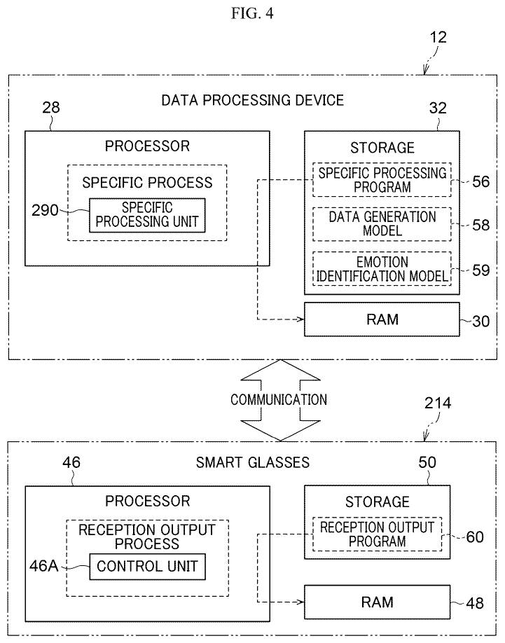

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

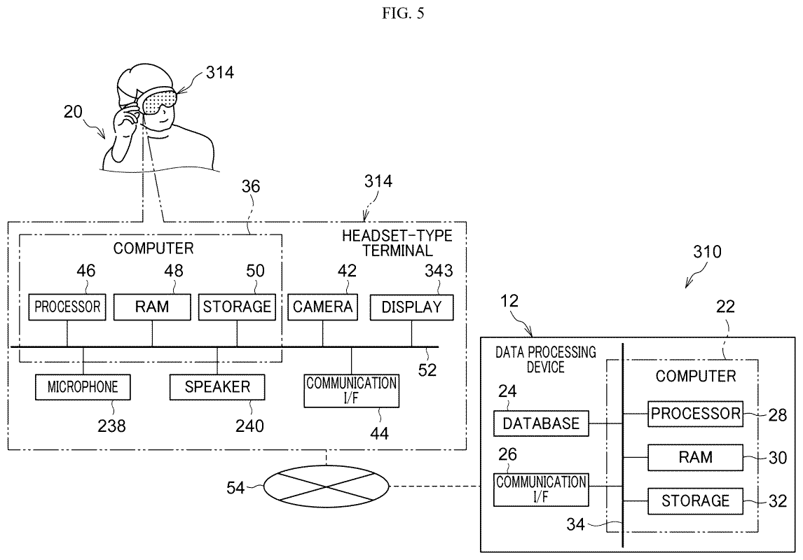

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

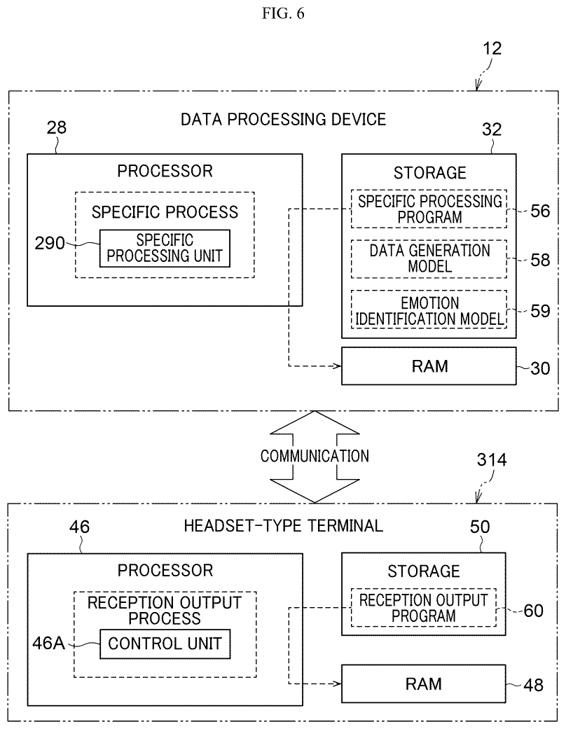

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

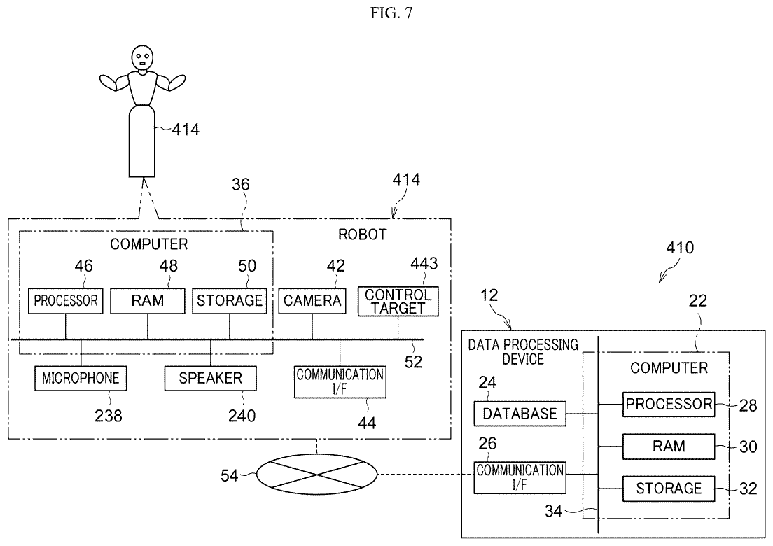

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

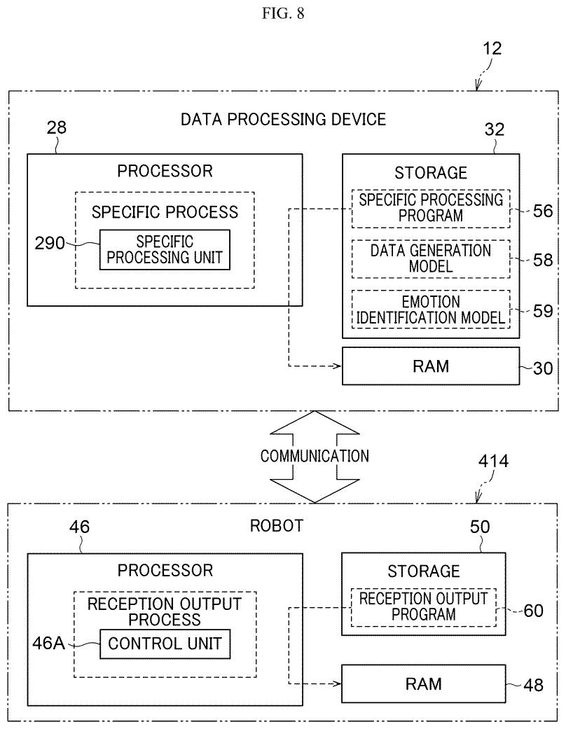

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

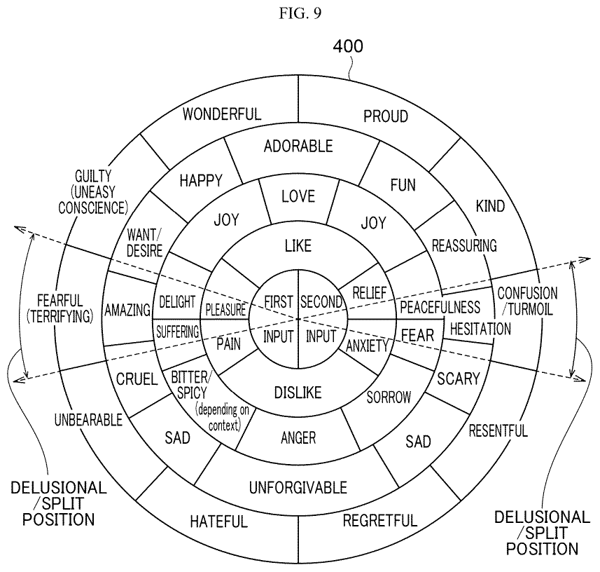

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

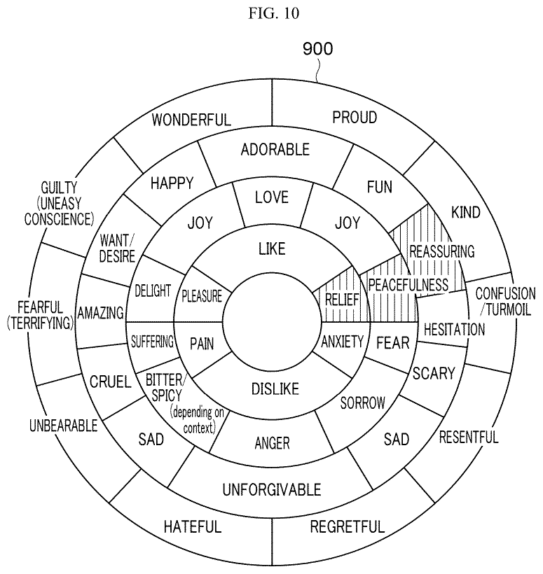

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
provide, via a communication network to a user terminal, a user input/output screen for inputting target information, object information, appeal point information, and evaluation index information, in response to a request from the user terminal,
receive, from the user terminal via a communication protocol, request data including the target information, the object information, the appeal point information, and the evaluation index information, and store the request data as structured data in an information storage area of a storage device,
generate, based on the target information, the object information, the appeal point information, and the evaluation index information stored in the information storage area, a prompt sentence in which text generation conditions are embedded, and record the prompt sentence in a prompt recording area in association with the structured data,
transmit, to an external natural language generation information processing service via a communication interface, generation request data including the prompt sentence and generation condition parameters, cause a generative AI model executed by the external natural language generation information processing service to automatically generate promotional text data based on the prompt sentence, and receive the promotional text data as response data,
store the promotional text data received as the response data in a generation result recording area in association with the prompt sentence and the target information, and output the promotional text data to the user terminal by converting the promotional text data into a format displayable on the user input/output screen or into an electronic distribution format,
collect, after the promotional text data has been distributed, reaction information including at least one of a number of clicks, a number of views, and a number of conversions from an external analysis service or an advertising distribution service, and perform statistical processing and aggregation processing on the reaction information in association with the evaluation index information to calculate an evaluation index value, and
generate a reward signal using at least the prompt sentence, the promotional text data, and the evaluation index value, apply a reinforcement learning algorithm implemented by a machine learning library based on the reward signal, and update at least one of the generation condition parameters for the generative AI model and a generation rule for the prompt sentence so as to control generation of promotional text data in subsequent executions such that the evaluation index value is increased.

### (Supplementary 2)

The system according to supplementary 1,
wherein the processor is configured to
convert the promotional text data into at least one of an electronic message format and an advertising display format compatible with at least one of an electronic mail distribution system, an advertising distribution system, and an information display system, and to transmit the promotional text data in the converted format to the electronic mail distribution system, the advertising distribution system, or the information display system via the communication interface.

### (Supplementary 3)

The system according to supplementary 1,
wherein the processor is configured to
store, in the information storage area, evaluation input information or comparative selection results for a plurality of pieces of promotional text data, the evaluation input information or the comparative selection results being input from the user terminal, as evaluation information separate from the evaluation index value, and to use the evaluation information in combination with the evaluation index value as the reward signal in the reinforcement learning algorithm, thereby dynamically changing at least one of a writing style and a structure of the prompt sentence and the generation condition parameters, and updating a method for generating the prompt sentence in subsequent executions.

### Application Example 1

### (Supplementary 1)

A system comprising a processor,
wherein the processor is configured to
display, via a user input/output device, an input interface that allows a user to input information including a promotion target, an appeal subject, a point to be emphasized, and an evaluation indicator, and receive character string information input through the input interface,
store the received character string information as structured data in a storage device, and perform normalization processing and removal of unnecessary characters on the structured data so as to generate generation data,
generate a prompt sentence for input to a generative AI model by combining respective items of the generation data as labeled text, and by constructing the prompt sentence including indications of “target,” “appeal content,” “recommended point,” “evaluation indicator,” and instruction text relating to generation conditions,
input the prompt sentence, via a communication network, into the generative AI model that is arranged externally or internally, cause the generative AI model to automatically generate promotional text data based on natural language processing, and extract the promotional text data from a response data set,
perform post-processing on the extracted promotional text data including deletion of unnecessary parts, truncation based on a character count limit, correction of notation inconsistencies, and format adjustment, thereby generating a final promotional text, display the final promotional text on a user interface of the user input/output device, and accept an editing operation by the user,
acquire the final promotional text confirmed by the user together with designation information of a distribution medium, and transmit the final promotional text, through the communication network using a connection application interface of an external information distribution platform, as an electronic message service or an information sharing service,
acquire, from the external information distribution platform or an access analysis platform, log data indicating user behavior including a number of displays, a number of selections, a number of conversions, and other usage actions associated with the final promotional text, and collect and analyze user reaction data by aggregating and calculating evaluation values corresponding to the evaluation indicator,
and use the evaluation values as a reward signal, execute a learning process that performs a reinforcement learning algorithm to update internal parameters representing composition rules of the prompt sentence and generation conditions for the generative AI model, and adjust at least one of a prompt generation method and parameters of the generative AI model such that expression patterns, tones, lengths, and call-to-action expressions that yielded higher evaluation values are preferentially used in subsequent prompt sentence generation, thereby improving quality of promotional text data generated thereafter.

### (Supplementary 2)

The system according to supplementary 1,
wherein the processor is configured to store, in the storage device, the final promotional text, input information used for generation, the prompt sentence, the evaluation values, and an update history of the reinforcement learning algorithm in association with each other, to compute changes of the evaluation indicator in at least one of a time series unit and a campaign unit based on stored contents, to generate visualization data of the changes, and to output, to the user input/output device, an indicator display screen using the visualization data.

### (Supplementary 3)

The system according to supplementary 1,
wherein the processor is configured to automatically change instruction text, constraint conditions, and tone designations in the prompt sentence to be input to the generative AI model based on an update result of the reinforcement learning algorithm, and to dynamically set at least one of a temperature parameter, an output length limit parameter, and an occurrence frequency control parameter for the generative AI model, thereby enabling sequential generation of diverse promotional texts that achieve higher evaluation indicators even for identical input information.

### Example 2

### (Supplementary 1)

A system comprising a processor and a storage device,
wherein the processor is configured to
provide, on a user interface of an information input/output device, a user screen for input of segment information, promotion target information, key appeal information, and evaluation metric information by a user,
receive, via a communication circuit, the segment information, the promotion target information, the key appeal information, and the evaluation metric information input from the user screen, and store the received information as structured data in the storage device,
generate, based on the information stored in the storage device and execution history information including past campaign results, a prompt sentence in a natural language for instructing a generative AI model to generate a promotional text,
provide the generated prompt sentence to the generative AI model, cause the generative AI model to automatically generate a promotional text candidate optimized for the segment information and the key appeal information, and store a generation result of the promotional text candidate in association with the information stored in the storage device,
convert the promotional text candidate stored in the storage device into distribution data in a transmission format for an electronic communication medium or a display medium, and transmit the distribution data to a message delivery apparatus or an advertisement delivery apparatus,
acquire, from a measurement program or an analysis service, user reaction data corresponding to an opening operation, a selection operation, or a transition operation performed after the promotional text candidate is delivered, by using identification information, a tracking resource identifier, or a tracking image included in the distribution data, and accumulate the acquired user reaction data as event data in the storage device,
aggregate the accumulated event data to calculate a performance index value corresponding to the evaluation metric information, define a reward value based on the performance index value, and execute a reinforcement learning algorithm that receives, as a state, feature information representing the segment information, the promotion target information, the key appeal information, and the promotional text candidate, thereby updating at least one of a generation policy for the prompt sentence and a generation condition parameter supplied to the generative AI model,
automatically improve contents of a subsequently generated promotional text candidate by using the updated generation policy for the prompt sentence or the updated generation condition parameter, and
accept, for the generative AI model, an arbitrary prompt sentence created by the user, and present, on the user screen, an improvement proposal of a promotion strategy or an additional promotional text proposal output by the generative AI model based on the arbitrary prompt sentence.

### (Supplementary 2)

The system according to supplementary 1,
wherein the processor is configured to
cause the distribution data to be in a transmission format including at least one of character information, structured document information, and image information, the transmission format being an electronic message format or a network advertisement format, and cause the promotional text candidate to be automatically generated as the electronic message format or the network advertisement format.

### (Supplementary 3)

The system according to supplementary 1,
wherein the processor is configured to
store, in the storage device, generation rules that select at least one of a wording style, a text length, a structural element, and an appeal pattern for each combination of the segment information, the promotion target information, and the key appeal information, based on the generation policy for the prompt sentence updated by the reinforcement learning algorithm, and, at a time of automatic generation of a subsequent promotional text candidate, refer to the generation rules and automatically generate a prompt sentence from which a higher performance index value corresponding to the evaluation metric information is expected.

### Application Example 2

### (Supplementary 1)

A system comprising a processor,
wherein the processor is configured to
control an input/output apparatus including a display screen accessed by a terminal so that a user can input information including a target group, an offering object, emphasis items, performance indicators, and optional free-text information via an information input screen,
receive, via a communication line from the terminal, the input information and identification information corresponding to the input information, and store the input information as structured data in a storage apparatus,
perform character string normalization processing and feature extraction processing on the input information stored in the storage apparatus, and generate feature data including target group information, offering object information, emphasis item information, performance indicator information, and free-text information,
perform natural language processing and classification processing on the free-text information or on evaluation information acquired from the user, calculate emotion type information indicating an emotional state and confidence information of the emotion type information, and store the emotion type information in association with the feature data in the storage apparatus,
select an instruction template into which an explanatory text describing the target group, the offering object, the emphasis items, the performance indicators, and the emotional state is embedded, based on the feature data and the emotion type information, and automatically create a prompt sentence that instructs a generative AI model to generate a promotional text by inserting the feature data into predetermined positions in the instruction template,
transmit request data including the prompt sentence and model control parameters to an information processing apparatus that provides the generative AI model operating on an external arithmetic apparatus, and receive, from the generative AI model, a plurality of candidate promotional texts output in response to the prompt sentence,
perform evaluation processing on the plurality of candidate promotional texts based on at least one of length, phrase composition, presence or absence of prohibited terms, and a quality evaluation value, select at least one effective promotional text based on a result of the evaluation processing, and output the effective promotional text in a format presentable to the user via the input/output apparatus,
convert the effective promotional text into distribution data according to a predetermined distribution method, add tracking identification information to link information in the distribution data, transmit the distribution data to recipients via an electronic communication network, and store distribution history information relating to the distribution processing in the storage apparatus,
acquire, from an analysis information processing apparatus, user reaction information indicating at least one of opening, selection, transition, and outcome occurrence measured in correspondence with the distribution data and emotion type information at a time of the user reaction, and store the user reaction information as evaluation result data aggregated for each performance indicator in the storage apparatus,
subject historical data including the evaluation result data, the emotion type information, the prompt sentence, and the candidate promotional texts to preprocessing as learning data, apply a reinforcement learning algorithm using a machine learning library to learn a policy model that outputs at least one of a configuration method of the prompt sentence and a generation policy of the promotional text, and update parameters of the policy model using, as a reward value, an evaluation value based on the performance indicators, and
determine, dynamically and based on the updated policy model, at least one of template selection, tone designation, length designation, and structural designation for a prompt sentence to be generated subsequently, and adaptively optimize the prompt sentence input to the generative AI model.

### (Supplementary 2)

The system according to supplementary 1,
wherein the processor is configured to format the effective promotional text into at least one of an electronic mail message, an information display screen, an electronic advertisement slot, an information distribution page, and a social networking service post, and to add the tracking identification information to each such format so as to generate the distribution data in a form in which the performance indicators are measurable.

### (Supplementary 3)

The system according to supplementary 1,
wherein the processor is configured to update, based on the evaluation result data and the emotion type information, a prompt generation model or a template selection rule that is separate from the policy model, and to automatically modify a generation method of the prompt sentence such that, according to the target group, the offering object, the emphasis items, the performance indicators, and the emotional state, at least one of elements to be emphasized in the prompt sentence and an order of description in the prompt sentence is changed so as to improve the performance indicators of a text output from the generative AI model at a time of next promotional text generation.

What is claimed is:

1. A system comprising:
circuitry configured to:
receive, via a packet-switched network from a terminal device, structured input data comprising a plurality of parameter fields;
store the structured input data as indexed records in a storage area of a non-transitory storage medium;
retrieve the indexed records from the storage area and construct, according to a configurable composition rule set, a prompt data sequence embedding the plurality of parameter fields into a natural-language instruction format;
record the prompt data sequence in a prompt storage area in association with the indexed records;
transmit, via a communication interface coupled to the packet-switched network, a generation request comprising the prompt data sequence and a set of generation condition parameters to a generative neural network model;
receive, from the generative neural network model, output text data generated in response to the prompt data sequence;
store the output text data in a result storage area in association with the prompt data sequence and the indexed records;
transmit the output text data to the terminal device for rendering on a display;
collect, from at least one external analysis apparatus coupled to the packet-switched network, interaction event data indicating actions performed in response to delivery of the output text data;
compute, by performing aggregation processing on the interaction event data in association with a performance metric specification contained in the structured input data, a performance index value;
generate a reward signal based on at least the prompt data sequence, the output text data, and the performance index value; and
execute a reinforcement learning algorithm that receives the reward signal and updates at least one of the set of generation condition parameters and the configurable composition rule set, such that subsequent generation requests yield output text data associated with a higher performance index value.

2. The system according to claim 1, wherein the generative neural network model comprises a transformer architecture including a plurality of self-attention layers, a plurality of feed-forward sublayers, and learned token embeddings, and wherein the generation condition parameters comprise at least a temperature scalar controlling a sampling probability distribution over a vocabulary of tokens.

3. The system according to claim 2, wherein the circuitry is further configured to set, as part of the generation condition parameters, at least one of a top-k sampling threshold, a nucleus sampling probability threshold, and a maximum output token count, and wherein the generative neural network model iteratively selects output tokens conditioned on the prompt data sequence until an end-of-sequence condition or the maximum output token count is reached.

4. The system according to claim 3, wherein the reinforcement learning algorithm comprises a policy network realized as a neural network, wherein inputs to the policy network comprise feature vectors derived from the structured input data and historical performance statistics, and wherein outputs of the policy network comprise at least selection probabilities for composition patterns of the prompt data sequence and suggested values for the generation condition parameters.

5. The system according to claim 4, wherein the reward signal is computed by a reward function that receives at least a normalized ratio derived from the interaction event data and explicit evaluation information received from the terminal device, and wherein the output text data comprises promotional text data generated for distribution via at least one of an electronic message format and a digital advertisement format.

6. The system according to claim 1, wherein the circuitry is further configured to convert the output text data into distribution data formatted for transmission via an electronic communication medium, embed tracking identification information and at least one of a tracking resource identifier and a tracking image into the distribution data, and transmit the distribution data to at least one of a message delivery apparatus and an advertisement delivery apparatus coupled to the packet-switched network.

7. The system according to claim 6, wherein the interaction event data comprises event records each including at least an event type, a timestamp, and the tracking identification information, and wherein the event type indicates at least one of an opening operation, a selection operation, a transition operation, and an outcome occurrence.

8. The system according to claim 7, wherein the circuitry computes the performance index value by dividing a count of event records having a first event type by a count of event records having a second event type, and wherein the performance metric specification identifies at least one of a click-through rate, a conversion rate, and an open rate.

9. The system according to claim 8, wherein the circuitry stores the performance index value in the non-transitory storage medium in association with the prompt data sequence, the generation condition parameters, and the indexed records, and wherein the reinforcement learning algorithm retrieves a plurality of past prompt-text-metric tuples from the non-transitory storage medium as training data for gradient-based optimization of the policy network.

10. The system according to claim 1, wherein the circuitry is further configured to perform normalization processing on the structured input data comprising at least one of character encoding unification, whitespace trimming, punctuation standardization, and numerical format canonicalization, and to store a normalized representation as the indexed records.

11. The system according to claim 10, wherein the configurable composition rule set comprises a plurality of instruction templates each defining placeholder positions and fixed instruction text, and wherein constructing the prompt data sequence comprises selecting an instruction template from the plurality of instruction templates and inserting normalized parameter fields into the placeholder positions.

12. The system according to claim 11, wherein the circuitry records, in the prompt storage area, a template identifier and a version identifier representing a state of the configurable composition rule set at a time of constructing the prompt data sequence, such that the circuitry can reproduce historical generation conditions for evaluation.

13. The system according to claim 1, wherein the circuitry is further configured to perform post-processing on the output text data comprising at least one of deletion of extraneous prefix text, truncation at a token boundary based on a character count limit, correction of notation inconsistencies, and format adjustment for a target distribution channel.

14. The system according to claim 13, wherein the circuitry receives a plurality of candidate output text items from the generative neural network model, performs evaluation processing on each candidate based on at least one of length, phrase composition, presence or absence of prohibited terms, and a quality evaluation score, and selects at least one candidate as the output text data based on a result of the evaluation processing.

15. The system according to claim 1, wherein the circuitry is further configured to perform natural language processing and classification processing on at least a portion of the structured input data to compute emotion type information indicating an emotional state and confidence information associated with the emotion type information, and to store the emotion type information in the non-transitory storage medium in association with the indexed records.

16. The system according to claim 15, wherein constructing the prompt data sequence further comprises embedding the emotion type information as an additional parameter field into the natural-language instruction format, such that the generative neural network model generates the output text data conditioned on the emotional state.

17. The system according to claim 1, wherein the circuitry is further configured to receive, from the terminal device, an arbitrary prompt data sequence composed by a user, augment the arbitrary prompt data sequence with historical performance statistics retrieved from the non-transitory storage medium, provide the augmented prompt data sequence to the generative neural network model, and transmit a resulting improvement proposal to the terminal device for rendering on the display.

18. A system comprising:
circuitry configured to:
receive, via a packet-switched network from a terminal device, structured input data comprising a plurality of parameter fields;
perform normalization processing on the structured input data comprising character encoding unification and numerical format canonicalization, and store normalized indexed records in a non-transitory storage medium;
select an instruction template from a plurality of stored instruction templates based on the normalized indexed records, and construct a prompt data sequence by inserting parameter fields from the normalized indexed records into placeholder positions of the selected instruction template;
transmit, via a communication interface, a generation request comprising the prompt data sequence and generation condition parameters including a temperature scalar and a maximum output token count to a generative neural network model comprising a transformer architecture with a plurality of self-attention layers;
receive a plurality of candidate output text items from the generative neural network model;
perform evaluation processing on each candidate output text item based on at least one of length, phrase composition, and a quality evaluation score, and select at least one candidate as output text data;
convert the output text data into distribution data, embed tracking identification information into the distribution data, and transmit the distribution data via the packet-switched network;
collect interaction event data from at least one external analysis apparatus by decoding the tracking identification information, and aggregate the interaction event data to compute a performance index value;
generate a reward signal from at least the performance index value and execute a reinforcement learning algorithm comprising a policy network to update at least one of a composition rule for the instruction template and the generation condition parameters; and
construct, using updated parameters from the policy network, a subsequent prompt data sequence predicted to yield a higher performance index value.

19. The system according to claim 18, wherein the circuitry is further configured to receive, from the terminal device, explicit evaluation information comprising at least one of ratings and comparative selection results among the plurality of candidate output text items, and to incorporate the explicit evaluation information into the reward signal used by the reinforcement learning algorithm.

20. A method comprising:
receiving, by circuitry via a packet-switched network from a terminal device, structured input data comprising a plurality of parameter fields;
storing the structured input data as indexed records in a storage area of a non-transitory storage medium;
constructing, according to a configurable composition rule set, a prompt data sequence embedding the plurality of parameter fields into a natural-language instruction format;
transmitting, via a communication interface coupled to the packet-switched network, a generation request comprising the prompt data sequence and a set of generation condition parameters to a generative neural network model;
receiving, from the generative neural network model, output text data generated in response to the prompt data sequence;
transmitting the output text data to the terminal device for rendering on a display;
collecting, from at least one external analysis apparatus coupled to the packet-switched network, interaction event data indicating actions performed in response to delivery of the output text data;
computing, by performing aggregation processing on the interaction event data, a performance index value;
generating a reward signal based on at least the prompt data sequence, the output text data, and the performance index value; and
executing a reinforcement learning algorithm that receives the reward signal and updates at least one of the set of generation condition parameters and the configurable composition rule set.
